(19) United States
(12) Patent Application Publication
(10) Pub. No.: US 2026/0081360 A1
(43) Pub. Date: Mar. 19, 2026

(54) APPARATUS, SYSTEM, AND METHOD OF CONTROLLING A POLARIZATION FOR AN ANTENNA

(71) Applicant: MobilEye Vision Technologies Ltd., Jerusalem (IL)

(72) Inventors: Naftali Landsberg, Kiryat Ono (IL); Ophir Shabtay, Tsofit (IL); Kobi Ben-Atar, Mazkeret Batya (IL)

(73) Assignee: MobilEye Vision Technologies Ltd., Jerusalem (IL)

(21) Appl. No.: 19/286,720

(22) Filed: Jul. 31, 2025

Related U.S. Application Data
(60) Provisional application No. 63/696,094, filed on Sep. 18, 2024.

(51) Int. Cl. H01Q 15/24; G01S 7/02; H01Q 1/32

(52) U.S. Cl. CPC H01Q 15/24; G01S 7/0231; H01Q 1/3233

(57) ABSTRACT

For example, a polarization controller may be configured to control a polarization for an antenna. For example, the polarization controller may include a processor, which may be configured to process interference information to identify angle-based information. For example, the angle-based information may be based on an angle of an interferer signal relative to a boresight of the antenna. For example, the processor may be configured to determine a polarization setting of the antenna based on the angle-based information. For example, the polarization controller may include an output to provide a control output to control the polarization for the antenna based on the polarization setting.

### CROSS-REFERENCE

This application claims the benefit of and priority from U.S. Provisional Patent Application No. 63/696,094, entitled “APPARATUS, SYSTEM, AND METHOD OF CONTROLLING A POLARIZATION FOR AN ANTENNA”, filed Sep. 18, 2024, the entire disclosure of which is incorporated herein by reference.

### BACKGROUND

Polarization is a property of a wave, which may define a geometrical orientation of oscillations of the wave.

The polarization of a Radio-Frequency (RF) wave, which is communicated via an antenna, may be determined by one or more polarization settings of the antenna.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a vehicle implementing a radar, in accordance with some demonstrative aspects.

FIG. 2 is a schematic block diagram illustration of a robot implementing a radar, in accordance with some demonstrative aspects.

FIG. 3 is a schematic block diagram illustration of a radar apparatus, in accordance with some demonstrative aspects.

FIG. 4 is a schematic block diagram illustration of a Frequency-Modulated Continuous Wave (FMCW) radar apparatus, in accordance with some demonstrative aspects.

FIG. 5 is a schematic illustration of an extraction scheme, which may be implemented to extract range and speed (Doppler) estimations from digital reception radar data values, in accordance with some demonstrative aspects.

FIG. 6 is a schematic illustration of an angle-determination scheme, which may be implemented to determine Angle of Arrival (AoA) information based on an incoming radio signal received by a receive antenna array, in accordance with some demonstrative aspects.

FIG. 7 is a schematic illustration of a Multiple-Input-Multiple-Output (MIMO) radar antenna scheme, which may be implemented based on a combination of Transmit (Tx) and Receive (Rx) antennas, in accordance with some demonstrative aspects.

FIG. 8 is a schematic block diagram illustration of elements of a radar device including a radar frontend and a radar processor, in accordance with some demonstrative aspects.

FIG. 9 is a schematic illustration of a radar system including a plurality of radar devices implemented in a vehicle, in accordance with some demonstrative aspects.

FIG. 10 is a schematic illustration of an interference scenario to demonstrate a technical aspect, which may be addressed in accordance with some demonstrative aspects.

FIG. 11 is a schematic illustration of an interference scenario to demonstrate a technical aspect, which may be addressed in accordance with some demonstrative aspects.

FIG. 12 is a schematic illustration of an interference scenario to demonstrate a technical aspect, which may be addressed in accordance with some demonstrative aspects.

FIG. 13 is a schematic illustration of a graph depicting a cross-polarization (Xpol) ratio of an antenna to demonstrate a technical aspect, which may be addressed in accordance with some demonstrative aspects.

FIG. 14 is a schematic illustration of a system, in accordance with some demonstrative aspects.

FIG. 15 is a schematic illustration of a graph depicting an Xpol ratio of an antenna, in accordance with some demonstrative aspects.

FIG. 16 is a schematic illustration of a polarization-setting scheme to determine a polarization setting of an antenna, in accordance with some demonstrative aspects.

FIG. 17 is a schematic illustration of a system, in accordance with some demonstrative aspects.

FIG. 18 is a schematic illustration of a dual-polarization receiver, in accordance with some demonstrative aspects.

FIG. 19 is a schematic illustration of a dual-polarization transmitter, in accordance with some demonstrative aspects.

FIG. 20 is a schematic flow chart illustration of a method of determining a polarization setting of an antenna, in accordance with some demonstrative aspects.

FIG. 21 is a schematic flow chart illustration of a method of determining one or more polarization settings of one or more sub-arrays of an antenna, in accordance with some demonstrative aspects.

FIG. 22 is a schematic flow chart illustration of a method of controlling a polarization for an antenna, in accordance with some demonstrative aspects.

FIG. 23 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

A “vehicle” may be understood to include any type of driven object. By way of example, a vehicle may be a driven object with a combustion engine, an electric engine, a reaction engine, an electrically driven object, a hybrid driven object, or a combination thereof. A vehicle may be, or may include, an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, a rocket, among others.

A “ground vehicle” may be understood to include any type of vehicle, which is configured to traverse the ground, e.g., on a street, on a road, on a track, on one or more rails, off-road, or the like.

An “autonomous vehicle” may describe a vehicle capable of implementing at least one navigational change without driver input. A navigational change may describe or include a change in one or more of steering, braking, acceleration/deceleration, or any other operation relating to movement, of the vehicle. A vehicle may be described as autonomous even in case the vehicle is not fully autonomous, for example, fully operational with driver or without driver input. Autonomous vehicles may include those vehicles that can operate under driver control during certain time periods, and without driver control during other time periods. Additionally or alternatively, autonomous vehicles may include vehicles that control only some aspects of vehicle navigation, such as steering, e.g., to maintain a vehicle course between vehicle lane constraints, or some steering operations under certain circumstances, e.g., not under all circumstances, but may leave other aspects of vehicle navigation to the driver, e.g., braking or braking under certain circumstances. Additionally or alternatively, autonomous vehicles may include vehicles that share the control of one or more aspects of vehicle navigation under certain circumstances, e.g., hands-on, such as responsive to a driver input; and/or vehicles that control one or more aspects of vehicle navigation under certain circumstances, e.g., hands-off, such as independent of driver input. Additionally or alternatively, autonomous vehicles may include vehicles that control one or more aspects of vehicle navigation under certain circumstances, such as under certain environmental conditions, e.g., spatial areas, roadway conditions, or the like. In some aspects, autonomous vehicles may handle some or all aspects of braking, speed control, velocity control, steering, and/or any other additional operations, of the vehicle. An autonomous vehicle may include those vehicles that can operate without a driver. The level of autonomy of a vehicle may be described or determined by the Society of Automotive Engineers (SAE) level of the vehicle, e.g., as defined by the SAE, for example in SAE J3016 2018: Taxonomy and definitions for terms related to driving automation systems for on road motor vehicles, or by other relevant professional organizations. The SAE level may have a value ranging from a minimum level, e.g., level 0 (illustratively, substantially no driving automation), to a maximum level, e.g., level 5 (illustratively, full driving automation).

An “assisted vehicle” may describe a vehicle capable of informing a driver or occupant of the vehicle of sensed data or information derived therefrom.

The phrase “vehicle operation data” may be understood to describe any type of feature related to the operation of a vehicle. By way of example, “vehicle operation data” may describe the status of the vehicle, such as, the type of tires of the vehicle, the type of vehicle, and/or the age of the manufacturing of the vehicle. More generally, “vehicle operation data” may describe or include static features or static vehicle operation data (illustratively, features or data not changing over time). As another example, additionally or alternatively, “vehicle operation data” may describe or include features changing during the operation of the vehicle, for example, environmental conditions, such as weather conditions or road conditions during the operation of the vehicle, fuel levels, fluid levels, operational parameters of the driving source of the vehicle, or the like. More generally, “vehicle operation data” may describe or include varying features or varying vehicle operation data (illustratively, time varying features or data).

Some aspects may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

Some aspects may be used in conjunction with Radio Frequency (RF) systems, radar systems, vehicular radar systems, autonomous systems, robotic systems, detection systems, or the like.

Some demonstrative aspects may be used in conjunction with an RF frequency in a frequency band having a starting frequency above 10 Gigahertz (GHz), for example, a frequency band having a starting frequency between 10 GHz and 120 GHz. For example, some demonstrative aspects may be used in conjunction with an RF frequency having a starting frequency above 30 GHz, for example, above 45 GHZ, e.g., above 60 GHz. For example, some demonstrative aspects may be used in conjunction with an automotive radar frequency band, e.g., a frequency band between 76 GHz and 81 GHz. However, other aspects may be implemented utilizing any other suitable frequency bands, for example, a frequency band above 140 GHz, a frequency band of 300 GHz, a sub Terahertz (THz) band, a THz band, an Infra-Red (IR) band, and/or any other frequency band.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality In some aspects, some functions associated with the circuitry may be implemented by one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure, and/or arrangement of one or more antenna elements, components, units, assemblies, and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a MIMO (Multiple-Input Multiple-Output) array antenna, a single element antenna, a set of switched beam antennas, and/or the like. In one example, an antenna may be implemented as a separate element or an integrated element, for example, as an on-module antenna, an on-chip antenna, or according to any other antenna architecture.

Some demonstrative aspects are described herein with respect to RF radar signals. However, other aspects may be implemented with respect to, or in conjunction with, any other radar signals, wireless signals, IR signals, acoustic signals, optical signals, wireless communication signals, communication scheme, network, standard, and/or protocol. For example, some demonstrative aspects may be implemented with respect to systems, e.g., Light Detection Ranging (LiDAR) systems, and/or sonar systems, utilizing light and/or acoustic signals.

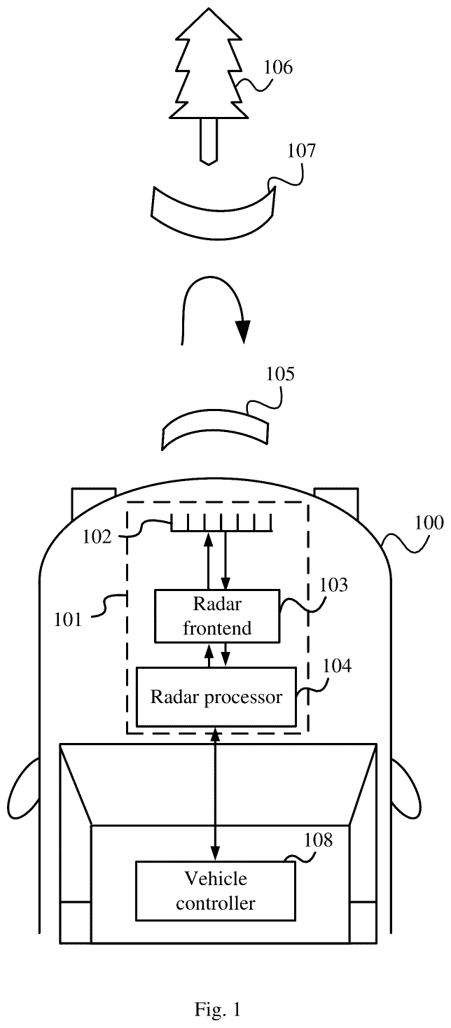

Reference is now made to FIG. 1, which schematically illustrates a block diagram of a vehicle 100 implementing a radar, in accordance with some demonstrative aspects.

In some demonstrative aspects, vehicle 100 may include a car, a truck, a motorcycle, a bus, a train, an airborne vehicle, a waterborne vehicle, a cart, a golf cart, an electric cart, a road agent, or any other vehicle.

In some demonstrative aspects, vehicle 100 may include a radar device 101, e.g., as described below. For example, radar device 101 may include a radar detecting device, a radar sensing device, a radar sensor, or the like, e.g., as described below.

In some demonstrative aspects, radar device 101 may be implemented as part of a vehicular system, for example, a system to be implemented and/or mounted in vehicle 100.

In one example, radar device 101 may be implemented as part of an autonomous vehicle system, an automated driving system, an assisted vehicle system, a driver assistance and/or support system, and/or the like.

For example, radar device 101 may be installed in vehicle 100 for detection of nearby objects, e.g., for autonomous driving.

In some demonstrative aspects, radar device 101 may be configured to detect targets in a vicinity of vehicle 100, e.g., in a far vicinity and/or a near vicinity, for example, using RF and analog chains, capacitor structures, large spiral transformers and/or any other electronic or electrical elements, e.g., as described below.

In one example, radar device 101 may be mounted onto, placed, e.g., directly, onto, or attached to, vehicle 100.

In some demonstrative aspects, vehicle 100 may include a plurality of radar aspects, vehicle 100 may include a single radar device 101.

In some demonstrative aspects, vehicle 100 may include a plurality of radar devices 101, which may be configured to cover a field of view of 360 degrees around vehicle 100.

In other aspects, vehicle 100 may include any other suitable count, arrangement, and/or configuration of radar devices and/or units, which may be suitable to cover any other field of view, e.g., a field of view of less than 360 degrees.

In some demonstrative aspects, radar device 101 may be implemented as a component in a suite of sensors used for driver assistance and/or autonomous vehicles, for example, due to the ability of radar to operate in nearly all-weather conditions.

In some demonstrative aspects, radar device 101 may be configured to support autonomous vehicle usage, e.g., as described below.

In one example, radar device 101 may determine a class, a location, an orientation, a velocity, an intention, a perceptional understanding of the environment, and/or any other information corresponding to an object in the environment.

In another example, radar device 101 may be configured to determine one or more parameters and/or information for one or more operations and/or tasks, e.g., path planning, and/or any other tasks.

In some demonstrative aspects, radar device 101 may be configured to map a scene by measuring targets' echoes (reflectivity) and discriminating them, for example, mainly in range, velocity, azimuth and/or elevation, e.g., as described below.

In some demonstrative aspects, radar device 101 may be configured to detect, and/or sense, one or more objects, which are located in a vicinity, e.g., a far vicinity and/or a near vicinity, of the vehicle 100, and to provide one or more parameters, attributes, and/or information with respect to the objects.

In some demonstrative aspects, the objects may include road users, such as other vehicles, pedestrians; road objects and markings, such as traffic signs, traffic lights, lane markings, road markings, road elements, e.g., a pavement-road meeting, a road edge, a road profile, road roughness (or smoothness); general objects, such as a hazard, e.g., a tire, a box, a crack in the road surface; and/or the like.

In some demonstrative aspects, the one or more parameters, attributes and/or information with respect to the object may include a range of the objects from the vehicle 100, an angle of the object with respect to the vehicle 100, a location of the object with respect to the vehicle 100, a relative speed of the object with respect to vehicle 100, and/or the like.

In some demonstrative aspects, radar device 101 may include a Multiple Input Multiple Output (MIMO) radar device 101, e.g., as described below.

In one example, the MIMO radar device may be configured to utilize “spatial filtering” processing, for example, beamforming and/or any other mechanism, for one or both of Transmit (Tx) signals and/or Receive (Rx) signals.

Some demonstrative aspects are described below with respect to a radar device, e.g., radar device 101, implemented as a MIMO radar. However, in other aspects, radar device 101 may be implemented as any other type of radar utilizing a plurality of antenna elements, e.g., a Single Input Multiple Output (SIMO) radar or a Multiple Input Single output (MISO) radar.

Some demonstrative aspects may be implemented with respect to a radar device, e.g., radar device 101, implemented as a MIMO radar, e.g., as described below. However, in other aspects, radar device 101 may be implemented as any other type of radar, for example, an Electronic Beam Steering radar, a Synthetic Aperture Radar (SAR), adaptive and/or cognitive radars that change their transmission according to the environment and/or ego state, a reflect array radar, or the like.

In some demonstrative aspects, radar device 101 may include an antenna arrangement 102, a radar frontend 103 configured to communicate radar signals via the antenna arrangement 102, and a radar processor 104 configured to generate radar information based on the radar signals, e.g., as described below.

In some demonstrative aspects, radar processor 104 may be configured to process radar information of radar device 101 and/or to control one or more operations of radar device 101, e.g., as described below.

In some demonstrative aspects, radar processor 104 may include, or may be implemented, partially or entirely, by circuitry and/or logic, e.g., one or more processors including circuitry and/or logic, memory circuitry and/or logic. Additionally or alternatively, one or more functionalities of radar processor 104 may be implemented by logic, which may be executed by a machine and/or one or more processors, e.g., as described below.

In one example, radar processor 104 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In other aspects, radar processor 104 may be implemented by one or more additional or alternative elements of vehicle 100.

In some demonstrative aspects, radar frontend 103 may include, for example, one or more (radar) transmitters, and one or more (radar) receivers, e.g., as described below.

In some demonstrative aspects, antenna arrangement 102 may include a plurality of antennas to communicate the radar signals. For example, antenna arrangement 102 may include multiple transmit antennas in the form of a transmit antenna array, and multiple receive antennas in the form of a receive antenna array. In another example, antenna arrangement 102 may include one or more antennas used both as transmit and receive antennas. In the latter case, the radar frontend 103, for example, may include a duplexer or a circulator, e.g., a circuit to separate transmitted signals from received signals.

In some demonstrative aspects, as shown in FIG. 1, the radar frontend 103 and the antenna arrangement 102 may be controlled, e.g., by radar processor 104, to transmit a radio transmit signal 105.

In some demonstrative aspects, as shown in FIG. 1, the radio transmit signal 105 may be reflected by an object 106, resulting in an echo 107.

In some demonstrative aspects, the radar device 101 may receive the echo 107, e.g., via antenna arrangement 102 and radar frontend 103, and radar processor 104 may generate radar information, for example, by calculating information about position, radial velocity (Doppler), and/or direction of the object 106, e.g., with respect to vehicle 100.

In some demonstrative aspects, radar processor 104 may be configured to provide the radar information to a vehicle controller 108 of the vehicle 100, e.g., for autonomous driving of the vehicle 100.

In some demonstrative aspects, at least part of the functionality of radar processor 104 may be implemented as part of vehicle controller 108. In other aspects, the functionality of radar processor 104 may be implemented as part of any other element of radar device 101 and/or vehicle 100. In other aspects, radar processor 104 may be implemented, as a separate part of, or as part of any other element of radar device 101 and/or vehicle 100.

In some demonstrative aspects, vehicle controller 108 may be configured to control one or more functionalities, modes of operation, components, devices, systems, and/or elements of vehicle 100.

In some demonstrative aspects, vehicle controller 108 may be configured to control one or more vehicular systems of vehicle 100, e.g., as described below.

In some demonstrative aspects, the vehicular systems may include, for example, a steering system, a braking system, a driving system, and/or any other system of the vehicle 100.

In some demonstrative aspects, vehicle controller 108 may configured to control radar device 101, and/or to process one or parameters, attributes and/or information from radar device 101.

In some demonstrative aspects, vehicle controller 108 may be configured, for example, to control the vehicular systems of the vehicle 100, for example, based on radar information from radar device 101 and/or one or more other sensors of the vehicle 100, e.g., Light Detection and Ranging (LIDAR) sensors, camera sensors, and/or the like.

In one example, vehicle controller 108 may control the steering system, the braking system, and/or any other vehicular systems of vehicle 100, for example, based on the information from radar device 101, e.g., based on one or more objects detected by radar device 101.

In other aspects, vehicle controller 108 may be configured to control any other additional or alternative functionalities of vehicle 100.

Some demonstrative aspects are described herein with respect to a radar device 101 implemented in a vehicle, e.g., vehicle 100. In other aspects a radar device, e.g., radar device 101, may be implemented as part of any other element of a traffic system or network, for example, as part of a road infrastructure, and/or any other element of a traffic network or system. Other aspects may be implemented with respect to any other system, environment, and/or apparatus, which may be implemented in any other object, environment, location, or place. For example, radar device 101 may be part of a non-vehicular device, which may be implemented, for example, in an indoor location, a stationary infrastructure outdoors, or any other location.

In some demonstrative aspects, radar device 101 may be configured to support security usage. In one example, radar device 101 may be configured to determine a nature of an operation, e.g., a human entry, an animal entry, an environmental movement, and the like, to identity a threat level of a detected event, and/or any other additional or alternative operations.

Some demonstrative aspects may be implemented with respect to any other additional or alternative devices and/or systems, for example, for a robot, e.g., as described below.

In other aspects, radar device 101 may be configured to support any other usages and/or applications.

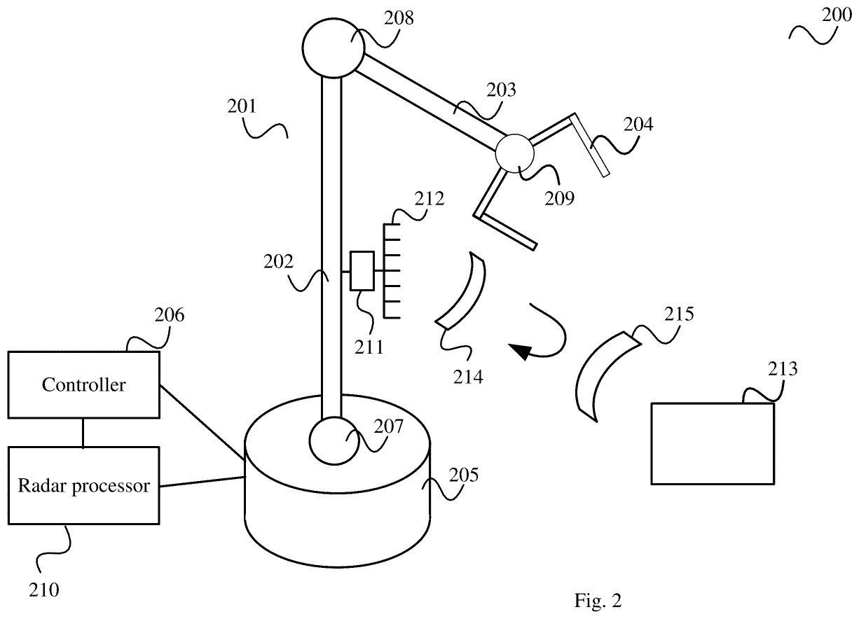

Reference is now made to FIG. 2, which schematically illustrates a block diagram of a robot 200 implementing a radar, in accordance with some demonstrative aspects.

In some demonstrative aspects, robot 200 may include a robot arm 201. The robot 200 may be implemented, for example, in a factory for handling an object 213, which may be, for example, a part that should be affixed to a product that is being manufactured. The robot arm 201 may include a plurality of movable members, for example, movable members 202, 203, 204, and a support 205. Moving the movable members 202, 203, and/or 204 of the robot arm 201, e.g., by actuation of associated motors, may allow physical interaction with the environment to carry out a task, e.g., handling the object 213.

In some demonstrative aspects, the robot arm 201 may include a plurality of joint elements, e.g., joint elements 207, 208, 209, which may connect, for example, the members 202, 203, and/or 204 with each other, and with the support 205. For example, a joint element 207, 208, 209 may have one or more joints, each of which may provide rotatable motion, e.g., rotational motion, and/or translatory motion, e.g., displacement, to associated members and/or motion of members relative to each other. The movement of the members 202, 203, 204 may be initiated by suitable actuators.

In some demonstrative aspects, the member furthest from the support 205, e.g., member 204, may also be referred to as the end-effector 204 and may include one or more tools, such as, a claw for gripping an object, a welding tool, or the like. Other members, e.g., members 202, 203, closer to the support 205, may be utilized to change the position of the end-effector 204, e.g., in three-dimensional space. For example, the robot arm 201 may be configured to function similarly to a human arm, e.g., possibly with a tool at its end.

In some demonstrative aspects, robot 200 may include a (robot) controller 206 configured to implement interaction with the environment, e.g., by controlling the robot arm's actuators, according to a control program, for example, in order to control the robot arm 201 according to the task to be performed.

In some demonstrative aspects, an actuator may include a component adapted to affect a mechanism or process in response to being driven. The actuator can respond to commands given by the controller 206 (the so-called activation) by performing mechanical movement. This means that an actuator, typically a motor (or electromechanical converter), may be configured to convert electrical energy into mechanical energy when it is activated (i.e., actuated).

In some demonstrative aspects, controller 206 may be in communication with a radar processor 210 of the robot 200.

In some demonstrative aspects, a radar fronted 211 and a radar antenna arrangement 212 may be coupled to the radar processor 210. In one example, radar fronted 211 and/or radar antenna arrangement 212 may be included, for example, as part of the robot arm 201.

In some demonstrative aspects, the radar frontend 211, the radar antenna arrangement 212 and the radar processor 210 may be operable as, and/or may be configured to form, a radar device. For example, antenna arrangement 212 may be configured to perform one or more functionalities of antenna arrangement 102 (FIG. 1), radar frontend 211 may be configured to perform one or more functionalities of radar frontend 103 (FIG. 1), and/or radar processor 210 may be configured to perform one or more functionalities of radar processor 104 (FIG. 1), e.g., as described above.

In some demonstrative aspects, for example, the radar frontend 211 and the antenna arrangement 212 may be controlled, e.g., by radar processor 210, to transmit a radio transmit signal 214.

In some demonstrative aspects, as shown in FIG. 2, the radio transmit signal 214 may be reflected by the object 213, resulting in an echo 215.

In some demonstrative aspects, the echo 215 may be received, e.g., via antenna arrangement 212 and radar frontend 211, and radar processor 210 may generate radar information, for example, by calculating information about position, speed (Doppler) and/or direction of the object 213, e.g., with respect to robot arm 201.

In some demonstrative aspects, radar processor 210 may be configured to provide the radar information to the robot controller 206 of the robot arm 201, e.g., to control robot arm 201. For example, robot controller 206 may be configured to control robot arm 201 based on the radar information, e.g., to grab the object 213 and/or to perform any other operation.

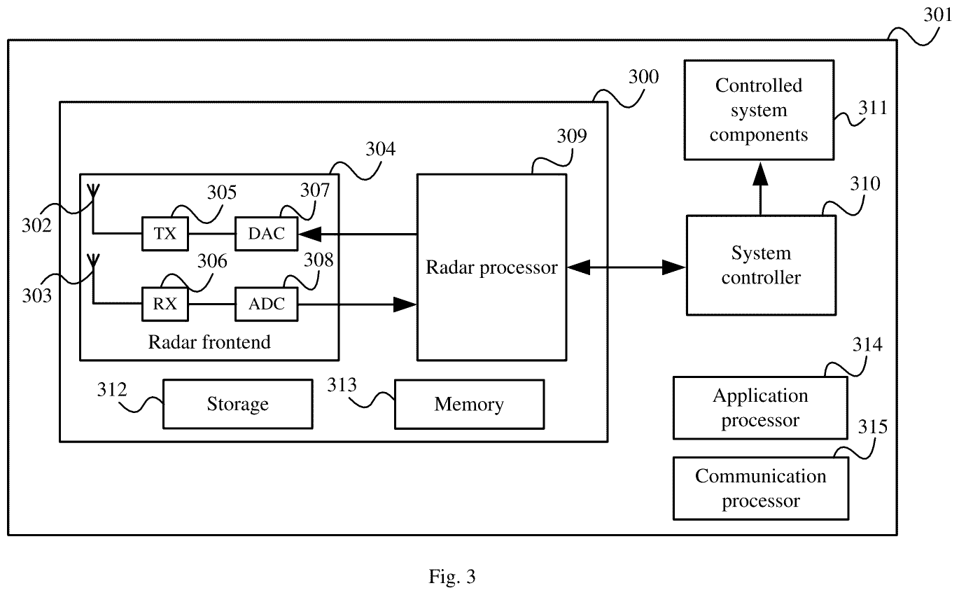

Reference is made to FIG. 3, which schematically illustrates a radar apparatus 300, in accordance with some demonstrative aspects.

In some demonstrative aspects, radar apparatus 300 may be implemented as part of a device or system 301, e.g., as described below.

For example, radar apparatus 300 may be implemented as part of, and/or may configured to perform one or more operations and/or functionalities of, the devices or systems described above with reference to FIG. 1 and/or FIG. 2. In other aspects, radar apparatus 300 may be implemented as part of any other device or system 301.

In some demonstrative aspects, radar device 300 may include an antenna arrangement, which may include one or more transmit antennas 302 and one or more receive antennas 303. In other aspects, any other antenna arrangement may be implemented.

In some demonstrative aspects, radar device 300 may include a radar frontend 304, and a radar processor 309.

In some demonstrative aspects, as shown in FIG. 3, the one or more transmit antennas 302 may be coupled with a transmitter (or transmitter arrangement) 305 of the radar frontend 304; and/or the one or more receive antennas 303 may be coupled with a receiver (or receiver arrangement) 306 of the radar frontend 304, e.g., as described below.

In some demonstrative aspects, transmitter 305 may include one or more elements, for example, an oscillator, a power amplifier and/or one or more other elements, configured to generate radio transmit signals to be transmitted by the one or more transmit antennas 302, e.g., as described below.

In some demonstrative aspects, for example, radar processor 309 may provide digital radar transmit data values to the radar frontend 304. For example, radar frontend 304 may include a Digital-to-Analog Converter (DAC) 307 to convert the digital radar transmit data values to an analog transmit signal. The transmitter 305 may convert the analog transmit signal to a radio transmit signal which is to be transmitted by transmit antennas 302.

In some demonstrative aspects, receiver 306 may include one or more elements, for example, one or more mixers, one or more filters and/or one or more other elements, configured to process, down-convert, radio signals received via the one or more receive antennas 303, e.g., as described below.

In some demonstrative aspects, for example, receiver 306 may convert a radio receive signal received via the one or more receive antennas 303 into an analog receive signal. The radar frontend 304 may include an Analog-to-Digital Converter (ADC) 308 to generate digital radar reception data values based on the analog receive signal. For example, radar frontend 304 may provide the digital radar reception data values to the radar processor 309.

In some demonstrative aspects, radar processor 309 may be configured to process the digital radar reception data values, for example, to detect one or more objects, e.g., in an environment of the device/system 301. This detection may include, for example, the determination of information including one or more of range, speed (Doppler), direction, and/or any other information, of one or more objects, e.g., with respect to the system 301.

In some demonstrative aspects, radar processor 309 may be configured to provide the determined radar information to a system controller 310 of device/system 301. For example, system controller 310 may include a vehicle controller, e.g., if device/system 301 includes a vehicular device/system, a robot controller, e.g., if device/system 301 includes a robot device/system, or any other type of controller for any other type of device/system 301.

In some demonstrative aspects, the radar information from radar processor 309 may be processed, e.g., by system controller 310 and/or any other element of system 301, for example, in combination with information from one or more other of information sources, for example, LiDAR information from a LiDAR processor, vision information from a vision-based processor, or the like.

In some demonstrative aspects, an environmental model of an environment of system 301 may be determined, e.g., by system controller 310 and/or any other element of system 301, for example, based on the radar information from radar processor 309, and/or the information from one or more other of information sources.

In some demonstrative aspects, a driving policy system, e.g., which may be implemented by system controller 310 and/or any other element of system 301, may process the environmental model, for example, to decide on one or more actions, which may be taken.

In some demonstrative aspects, system controller 310 may be configured to control one or more controlled system components 311 of the system 301, e.g., a motor, a brake, steering, and the like, e.g., by one or more corresponding actuators, for example, based on the one or more action decisions.

In some demonstrative aspects, radar device 300 may include a storage 312 or a memory 313, e.g., to store information processed by radar 300, for example, digital radar reception data values being processed by the radar processor 309, radar information generated by radar processor 309, and/or any other data to be processed by radar processor 309.

In some demonstrative aspects, device/system 301 may include, for example, an application processor 314 and/or a communication processor 315, for example, to at least partially implement one or more functionalities of system controller 310 and/or to perform communication between system controller 310, radar device 300, the controlled system components 311, and/or one or more additional elements of device/system 301.

In some demonstrative aspects, radar device 300 may be configured to generate and transmit the radio transmit signal in a form, which may support determination of range, speed, and/or direction, e.g., as described below.

For example, a radio transmit signal of a radar may be configured to include a plurality of pulses. For example, a pulse transmission may include the transmission of short high-power bursts in combination with times during which the radar device listens for echoes.

For example, in order to more optimally support a highly dynamic situation, e.g., in an automotive scenario, a continuous wave (CW) may instead be used as the radio transmit signal. However, a continuous wave, e.g., with constant frequency, may support velocity determination, but may not allow range determination, e.g., due to the lack of a time mark that could allow distance calculation.

In some demonstrative aspects, radio transmit signal 105 (FIG. 1) may be transmitted according to technologies such as, for example, Frequency-Modulated Continuous Wave (FMCW) radar, Phase-Modulated Continuous Wave (PMCW) radar, Orthogonal Frequency Division Multiplexing (OFDM) radar, and/or any other type of radar technology, which may support determination of range, velocity, and/or direction, e.g., as described below.

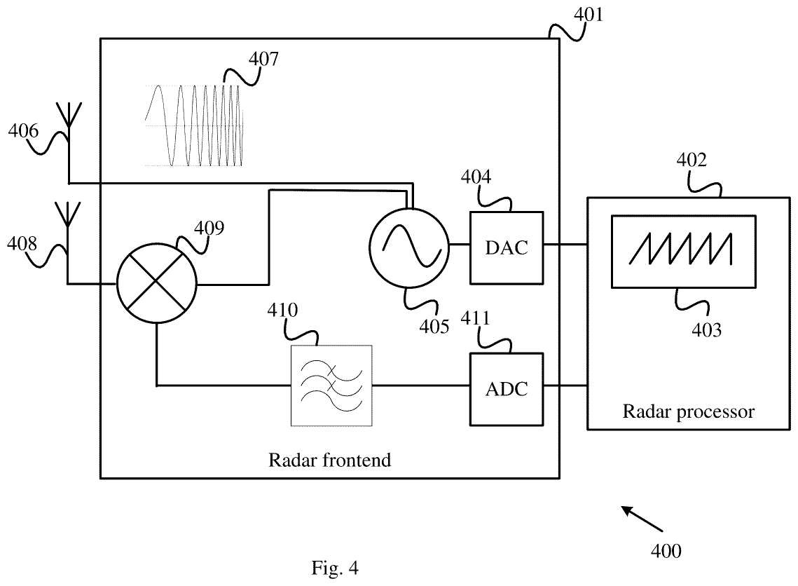

Reference is made to FIG. 4, which schematically illustrates a FMCW radar apparatus, in accordance with some demonstrative aspects.

In some demonstrative aspects, FMCW radar device 400 may include a radar frontend 401, and a radar processor 402. For example, radar frontend 304 (FIG. 3) may include one or more elements of, and/or may perform one or more operations and/or functionalities of, radar frontend 401; and/or radar processor 309 (FIG. 3) may include one or more elements of, and/or may perform one or more operations and/or functionalities of, radar processor 402.

In some demonstrative aspects, FMCW radar device 400 may be configured to communicate radio signals according to an FMCW radar technology, e.g., rather than sending a radio transmit signal with a constant frequency.

In some demonstrative aspects, radio frontend 401 may be configured to ramp up and reset the frequency of the transmit signal, e.g., periodically, for example, according to a saw tooth waveform 403. In other aspects, a triangle waveform, or any other suitable waveform may be used.

In some demonstrative aspects, for example, radar processor 402 may be configured to provide waveform 403 to frontend 401, for example, in digital form, e.g., as a sequence of digital values.

In some demonstrative aspects, radar frontend 401 may include a DAC 404 to convert waveform 403 into analog form, and to supply it to a voltage-controlled oscillator 405. For example, oscillator 405 may be configured to generate an output signal, which may be frequency-modulated in accordance with the waveform 403.

In some demonstrative aspects, oscillator 405 may be configured to generate the output signal including a radio transmit signal, which may be fed to and sent out by one or more transmit antennas 406.

In some demonstrative aspects, the radio transmit signal generated by the oscillator 405 may have the form of a sequence of chirps 407, which may be the result of the modulation of a sinusoid with the saw tooth waveform 403.

In one example, a chirp 407 may correspond to the sinusoid of the oscillator signal frequency-modulated by a “tooth” of the saw tooth waveform 403, e.g., from the minimum frequency to the maximum frequency.

In some demonstrative aspects, FMCW radar device 400 may include one or more receive antennas 408 to receive a radio receive signal. The radio receive signal may be based on the echo of the radio transmit signal, e.g., in addition to any noise, interference, or the like.

In some demonstrative aspects, radar frontend 401 may include a mixer 409 to mix the radio transmit signal with the radio receive signal into a mixed signal.

In some demonstrative aspects, radar frontend 401 may include a filter, e.g., a Low Pass Filter (LPF) 410, which may be configured to filter the mixed signal from the mixer 409 to provide a filtered signal. For example, radar frontend 401 may include an ADC 411 to convert the filtered signal into digital reception data values, which may be provided to radar processor 402. In another example, the filter 410 may be a digital filter, and the ADC 411 may be arranged between the mixer 409 and the filter 410.

In some demonstrative aspects, radar processor 402 may be configured to process the digital reception data values to provide radar information, for example, including range, speed (velocity/Doppler), and/or direction (AoA) information of one or more objects.

In some demonstrative aspects, radar processor 402 may be configured to perform a first Fast Fourier Transform (FFT) (also referred to as “range FFT”) to extract a delay response, which may be used to extract range information, and/or a second FFT (also referred to as “Doppler FFT”) to extract a Doppler shift response, which may be used to extract velocity information, from the digital reception data values.

In other aspects, any other additional or alternative methods may be utilized to extract range information. In one example, in a digital radar implementation, a correlation with the transmitted signal may be used, e.g., according to a matched filter implementation.

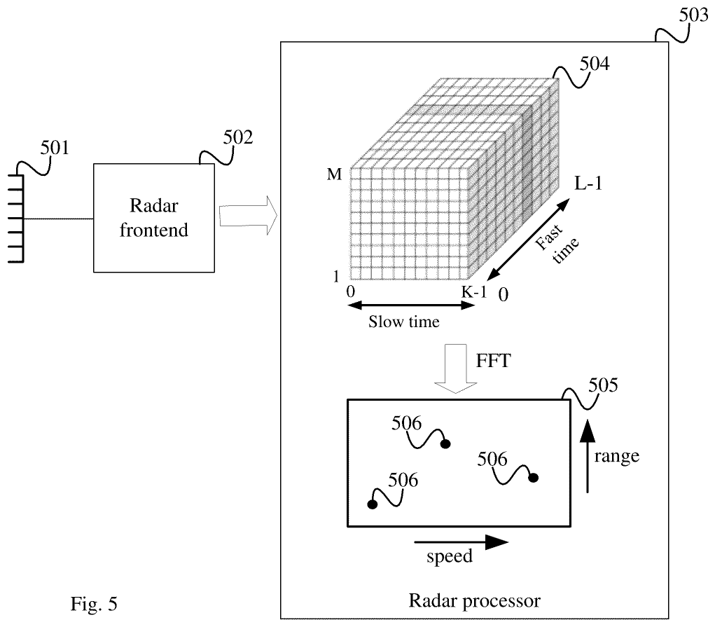

Reference is made to FIG. 5, which schematically illustrates an extraction scheme, which may be implemented to extract range and speed (Doppler) estimations from digital reception radar data values, in accordance with some demonstrative aspects. For example, radar processor 104 (FIG. 1), radar processor 210 (FIG. 2), radar processor 309 (FIG. 3), and/or radar processor 402 (FIG. 4), may be configured to extract range and/or speed (Doppler) estimations from digital reception radar data values according to one or more aspects of the extraction scheme of FIG. 5.

In some demonstrative aspects, as shown in FIG. 5, a radio receive signal, e.g., including echoes of a radio transmit signal, may be received by a receive antenna array 501. The radio receive signal may be processed by a radio radar frontend 502 to generate digital reception data values, e.g., as described above. The radio radar frontend 502 may provide the digital reception data values to a radar processor 503, which may process the digital reception data values to provide radar information, e.g., as described above.

In some demonstrative aspects, the digital reception data values may be represented in the form of a data cube 504. For example, the data cube 504 may include digitized samples of the radio receive signal, which is based on a radio signal transmitted from a transmit antenna and received by M receive antennas. In some demonstrative aspects, for example, with respect to a MIMO implementation, there may be multiple transmit antennas, and the number of samples may be multiplied accordingly.

In some demonstrative aspects, a layer of the data cube 504, for example, a horizontal layer of the data cube 504, may include samples of an antenna, e.g., a respective antenna of the M antennas.

In some demonstrative aspects, data cube 504 may include samples for K chirps. For example, as shown in FIG. 5, the samples of the chirps may be arranged in a so-called “slow time”-direction.

In some demonstrative aspects, the data cube 504 may include L samples, e.g., L=512 or any other number of samples, for a chirp, e.g., per each chirp. For example, as shown in FIG. 5, the samples per chirp may be arranged in a so-called “fast time”-direction of the data cube 504.

In some demonstrative aspects, radar processor 503 may be configured to process a plurality of samples, e.g., L samples collected for each chirp and for each antenna, by a first FFT. The first FFT may be performed, for example, for each chirp and each antenna, such that a result of the processing of the data cube 504 by the first FFT may again have three dimensions, and may have the size of the data cube 504 while including values for L range bins, e.g., instead of the values for the L sampling times.

In some demonstrative aspects, radar processor 503 may be configured to process the result of the processing of the data cube 504 by the first FFT, for example, by processing the result according to a second FFT along the chirps, e.g., for each antenna and for each range bin.

For example, the first FFT may be in the “fast time” direction, and the second FFT may be in the “slow time” direction.

In some demonstrative aspects, the result of the second FFT may provide, e.g., when aggregated over the antennas, a range/Doppler (R/D) map 505. The R/D map may have FFT peaks 506, for example, including peaks of FFT output values (in terms of absolute values) for certain range/speed combinations, e.g., for range/Doppler bins. For example, a range/Doppler bin may correspond to a range bin and a Doppler bin. For example, radar processor 503 may consider a peak as potentially corresponding to an object, e.g., of the range and speed corresponding to the peak's range bin and speed bin.

In some demonstrative aspects, the extraction scheme of FIG. 5 may be implemented for an FMCW radar, e.g., FMCW radar 400 (FIG. 4), as described above. In other aspects, the extraction scheme of FIG. 5 may be implemented for any other radar type. In one example, the radar processor 503 may be configured to determine a range/Doppler map 505 from digital reception data values of a PMCW radar, an OFDM radar, or any other radar technologies. For example, in adaptive or cognitive radar, the pulses in a frame, the waveform and/or modulation may be changed over time, e.g., according to the environment.

Referring back to FIG. 3, in some demonstrative aspects, receive antenna arrangement 303 may be implemented using a receive antenna array having a plurality of receive antennas (or receive antenna elements). For example, radar processor 309 may be configured to determine an angle of arrival of the received radio signal, e.g., echo 107 (FIG. 1) and/or echo 215 (FIG. 2). For example, radar processor 309 may be configured to determine a direction of a detected object, e.g., with respect to the device/system 301, for example, based on the angle of arrival of the received radio signal, e.g., as described below.

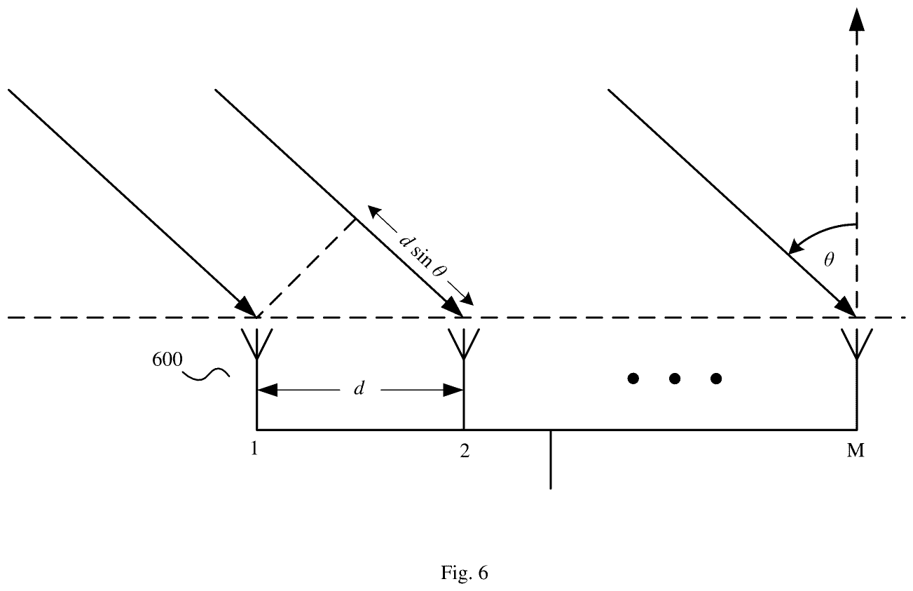

Reference is made to FIG. 6, which schematically illustrates an angle-determination scheme, which may be implemented to determine Angle of Arrival (AoA) information based on an incoming radio signal received by a receive antenna array 600, in accordance with some demonstrative aspects.

FIG. 6 depicts an angle-determination scheme based on received signals at the receive antenna array.

In some demonstrative aspects, for example, in a virtual MIMO array, the angle-determination may also be based on the signals transmitted by the array of Tx antennas.

FIG. 6 depicts a one-dimensional angle-determination scheme. Other multi-dimensional angle determination schemes, e.g., a two-dimensional scheme or a three-dimensional scheme, may be implemented.

In some demonstrative aspects, as shown in FIG. 6, the receive antenna array 600 may include M antennas (numbered, from left to right, 1 to M).

As shown by the arrows in FIG. 6, it is assumed that an echo is coming from an object located at the top left direction. Accordingly, the direction of the echo, e.g., the incoming radio signal, may be towards the bottom right. According to this example, the further to the left a receive antenna is located, the earlier it will receive a certain phase of the incoming radio signal.

For example, a phase difference, denoted Δφ, between two antennas of the receive antenna array 600 may be determined, e.g., as follows:

$$Δφ = \frac{2 π}{λ} \cdot d \cdot sin ( θ )$$

wherein λ denotes a wavelength of the incoming radio signal, d denotes a distance between the two antennas, and θ denotes an angle of arrival of the incoming radio signal, e.g., with respect to a normal direction of the array.

In some demonstrative aspects, radar processor 309 (FIG. 3) may be configured to utilize this relationship between phase and angle of the incoming radio signal, for example, to determine the angle of arrival of echoes, for example by performing an FFT, e.g., a third FFT (“angular FFT”) over the antennas.

In some demonstrative aspects, multiple transmit antennas, e.g., in the form of an antenna array having multiple transmit antennas, may be used, for example, to increase the spatial resolution, e.g., to provide high-resolution radar information. For example, a MIMO radar device may utilize a virtual MIMO radar antenna, which may be formed as a convolution of a plurality of transmit antennas convolved with a plurality of receive antennas.

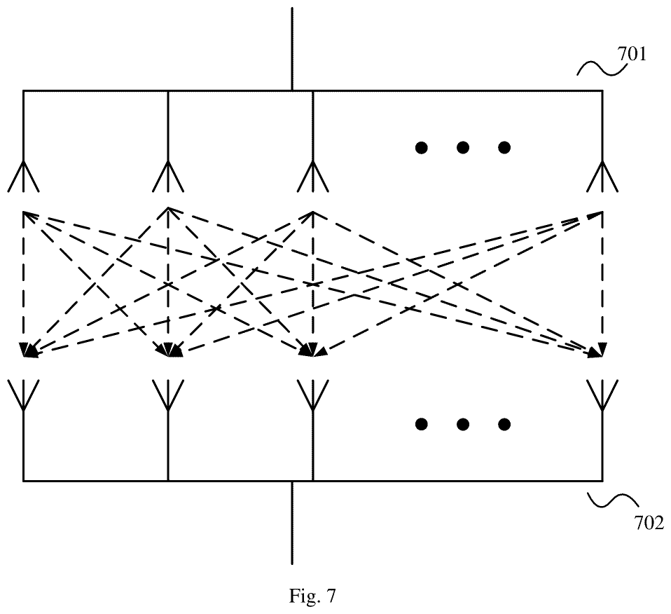

Reference is made to FIG. 7, which schematically illustrates a MIMO radar antenna scheme, which may be implemented based on a combination of Transmit (Tx) and Receive (Rx) antennas, in accordance with some demonstrative aspects.

In some demonstrative aspects, as shown in FIG. 7, a radar MIMO arrangement may include a transmit antenna array 701 and a receive antenna array 702. For example, the one or more transmit antennas 302 (FIG. 3) may be implemented to include transmit antenna array 701, and/or the one or more receive antennas 303 (FIG. 3) may be implemented to include receive antenna array 702.

In some demonstrative aspects, antenna arrays including multiple antennas both for transmitting the radio transmit signals and for receiving echoes of the radio transmit signals, may be utilized to provide a plurality of virtual channels as illustrated by the dashed lines in FIG. 7. For example, a virtual channel may be formed as a convolution, for example, as a Kronecker product, between a transmit antenna and a receive antenna, e.g., representing a virtual steering vector of the MIMO radar.

In some demonstrative aspects, a transmit antenna, e.g., each transmit antenna, may be configured to send out an individual radio transmit signal, e.g., having a phase associated with the respective transmit antenna.

For example, an array of N transmit antennas and M receive antennas may be implemented to provide a virtual MIMO array of size N×M. For example, the virtual MIMO array may be formed according to the Kronecker product operation applied to the Tx and Rx steering vectors.

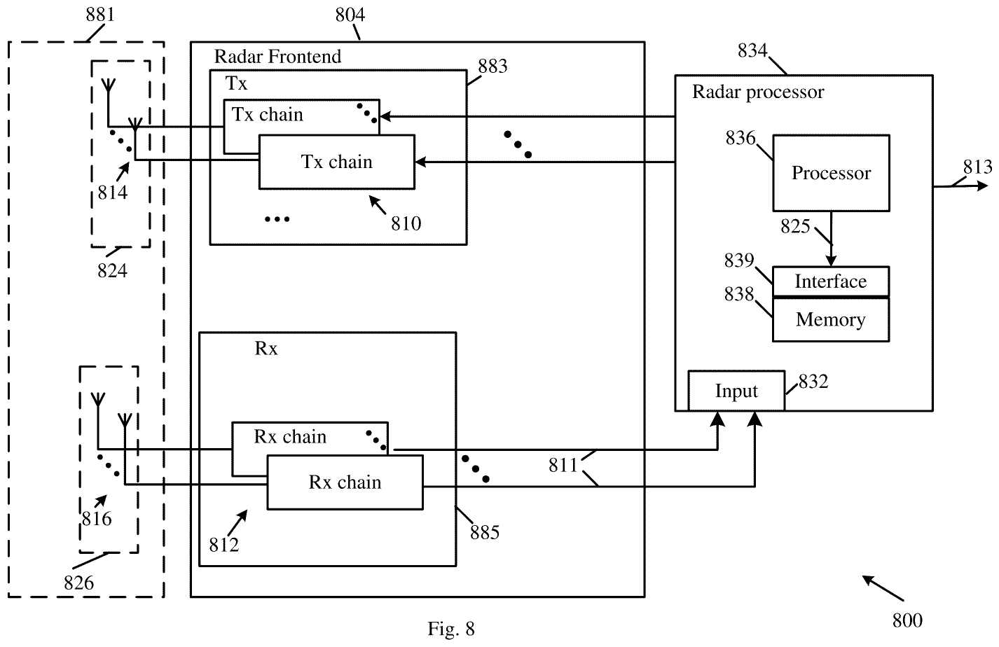

FIG. 8 is a schematic block diagram illustration of elements of a radar device 800, in accordance with some demonstrative aspects. For example, radar device 101 (FIG. 1), radar device 300 (FIG. 3), and/or radar device 400 (FIG. 4), may include one or more elements of radar device 800, and/or may perform one or more operations and/or functionalities of radar device 800.

In some demonstrative aspects, as shown in FIG. 8, radar device 800 may include a radar frontend 804 and a radar processor 834. For example, radar frontend 103 (FIG. 1), radar frontend 211 (FIG. 1), radar frontend 304 (FIG. 3), radar frontend 401 (FIG. 4), and/or radar frontend 502 (FIG. 5), may include one or more elements of radar frontend 804, and/or may perform one or more operations and/or functionalities of radar frontend 804.

In some demonstrative aspects, radar frontend 804 may be implemented as part of a MIMO radar utilizing a MIMO radar antenna 881 including a plurality of Tx antennas 814 configured to transmit a plurality of Tx RF signals (also referred to as “Tx radar signals”); and a plurality of Rx antennas 816 configured to receive a plurality of Rx RF signals (also referred to as “Rx radar signals”), for example, based on the Tx radar signals, e.g., as described below.

In some demonstrative aspects, MIMO antenna array 881, antennas 814, and/or antennas 816 may include or may be part of any type of antennas suitable for transmitting and/or receiving radar signals. For example, MIMO antenna array 881, antennas 814, and/or antennas 816, may be implemented as part of any suitable configuration, structure, and/or arrangement of one or more antenna elements, components, units, assemblies, and/or arrays. For example, MIMO antenna array 881, antennas 814, and/or antennas 816, may be implemented as part of a phased array antenna, a multiple element antenna, a set of switched beam antennas, and/or the like. In some aspects, MIMO antenna array 881, antennas 814, and/or antennas 816, may be implemented to support transmit and receive functionalities using separate transmit and receive antenna elements. In some aspects, MIMO antenna array 881, antennas 814, and/or antennas 816, may be implemented to support transmit and receive functionalities using common and/or integrated transmit/receive elements.

In some demonstrative aspects, MIMO radar antenna 881 may include a rectangular MIMO antenna array, and/or curved array, e.g., shaped to fit a vehicle design.

In other aspects, any other form, shape, and/or arrangement of MIMO radar antenna 881 may be implemented.

In some demonstrative aspects, radar frontend 804 may include one or more radios configured to generate and transmit the Tx RF signals via Tx antennas 814; and/or to process the Rx RF signals received via Rx antennas 816, e.g., as described below.

In some demonstrative aspects, radar frontend 804 may include at least one transmitter (Tx) 883 including circuitry and/or logic configured to generate and/or transmit the Tx radar signals via Tx antennas 814.

In some demonstrative aspects, radar frontend 804 may include at least one receiver (Rx) 885 including circuitry and/or logic to receive and/or process the Rx radar signals received via Rx antennas 816, for example, based on the Tx radar signals.

In some demonstrative aspects, transmitter 883, and/or receiver 885 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like.

In some demonstrative aspects, transmitter 883 may include a plurality of Tx chains 810 configured to generate and transmit the Tx RF signals via Tx antennas 814, e.g., respectively; and/or receiver 885 may include a plurality of Rx chains 812 configured to receive and process the Rx RF signals received via the Rx antennas 816, e.g., respectively.

In some demonstrative aspects, radar processor 834 may be configured to generate radar information 813, for example, based on the radar signals communicated by MIMO radar antenna 881, e.g., as described below. For example, radar processor 104 (FIG. 1), radar processor 210 (FIG. 2), radar processor 309 (FIG. 3), radar processor 402 (FIG. 4), and/or radar processor 503 (FIG. 5), may include one or more elements of radar processor 834, and/or may perform one or more operations and/or functionalities of radar processor 834.

In some demonstrative aspects, radar processor 834 may be configured to generate radar information 813, for example, based on radar Rx data 811 received from the plurality of Rx chains 812. For example, radar Rx data 811 may be based on the radar Rx signals received via the Rx antennas 816.

In some demonstrative aspects, radar processor 834 may include an input 832 to receive radar input data, e.g., including the radar Rx data 811 from the plurality of Rx chains 812.

In some demonstrative aspects, radar processor 834 may include, or may be implemented, partially or entirely, by circuitry and/or logic, e.g., one or more processors including circuitry and/or logic, memory circuitry and/or logic. Additionally or alternatively, one or more functionalities of radar processor 834 may be implemented by logic, which may be executed by a machine and/or one or more processors, e.g., as described below.

In some demonstrative aspects, radar processor 834 may include at least one processor 836, which may be configured, for example, to process the radar Rx data 811, and/or to perform one or more operations, methods, and/or algorithms.

In some demonstrative aspects, radar processor 834 may include at least one memory 838, e.g., coupled to the processor 836. For example, memory 838 may be configured to store data processed by radar processor 834. For example, memory 838 may store, e.g., at least temporarily, at least some of the information processed by the processor 836, and/or logic to be utilized by the processor 836.

In some demonstrative aspects, processor 836 may interface with memory 838, for example, via a memory interface 839.

In some demonstrative aspects, processor 836 may be configured to access memory 838, e.g., to write data to memory 838 and/or to read data from memory 838, for example, via memory interface 839.

In some demonstrative aspects, memory 838 may be configured to store at least part of the radar data, e.g., some of the radar Rx data or all of the radar Rx data, for example, for processing by processor 836, e.g., as described below.

In some demonstrative aspects, memory 838 may be configured to store processed data, which may be generated by processor 836, for example, during the process of generating the radar information 813, e.g., as described below.

In some demonstrative aspects, memory 838 may be configured to store range information and/or Doppler information, which may be generated by processor 836, for example, based on the radar Rx data. In one example, the range information and/or Doppler information may be determined based on a Cross-Correlation (XCORR) operation, which may be applied to the radar Rx data. Any other additional or alternative operation, algorithm, and/or procedure may be utilized to generate the range information and/or Doppler information.

In some demonstrative aspects, memory 838 may be configured to store AoA information, which may be generated by processor 836, for example, based on the radar Rx data, the range information and/or Doppler information. In one example, the AoA information may be determined based on an AoA estimation algorithm. Any other additional or alternative operation, algorithm, and/or procedure may be utilized to generate the AoA information.

In some demonstrative aspects, radar processor 834 may be configured to generate the radar information 813 including one or more of range information, Doppler information, and/or AoA information.

In some demonstrative aspects, the radar information 813 may include Point Cloud 1 (PC1) information, for example, including raw point cloud estimations, e.g., Range, Radial Velocity, Azimuth, and/or Elevation.

In some demonstrative aspects, the radar information 813 may include additional information, which may be, for example, based on the raw point cloud estimations, and/or may be related to the raw point cloud estimations.

In some demonstrative aspects, the radar information 813 may include metadata information corresponding to the raw point cloud estimations.

In some demonstrative aspects, the radar information 813 may include, for example, information relating to a reliability level of the raw point cloud estimations, information relating to one or more parameters, conditions and/or criteria implemented in determining the raw point cloud estimations, and/or any other suitable additional or alternative information.

For example, the radar information 813 may include Log Likelihood Ratio (LLR) information corresponding to the raw point cloud estimations, Radar Cross Section (RCS) estimation information, Signal to Noise Ratio (SNR) estimation information, and/or any other suitable additional or alternative information.

In some demonstrative aspects, the radar information 813 may include Point Cloud 2 (PC2) information, which may be generated, for example, based on the PC1 information. For example, the PC2 information may include clustering information, tracking information, e.g., tracking of probabilities and/or density functions, bounding box information, classification information, orientation information, and the like. In one example, the PC2 information may be based on one or more temporal filtering techniques, which may be applied to the PC1 information, for example, for temporal filtering of multiple frames and/or multiple PC1 instances.

In some demonstrative aspects, the radar information 813 may include target tracking information corresponding to a plurality of targets in an environment of the radar device 800, e.g., as described below.

In some demonstrative aspects, radar processor 834 may be configured to generate the radar information 813 in the form of four Dimensional (4D) image information, e.g., a cube, which may represent 4D information corresponding to one or more detected targets.

In some demonstrative aspects, the 4D image information may include, for example, range values, e.g., based on the range information, velocity values, e.g., based on the Doppler information, azimuth values, e.g., based on azimuth AoA information, elevation values, e.g., based on elevation AoA information, and/or any other values.

In some demonstrative aspects, radar processor 834 may be configured to generate the radar information 813 in any other form, and/or including any other additional or alternative information.

In some demonstrative aspects, radar processor 834 may be configured to process the signals communicated via MIMO radar antenna 881 as signals of a virtual MIMO array formed by a convolution of the plurality of Rx antennas 816 and the plurality of Tx antennas 814.

In some demonstrative aspects, radar frontend 804 and/or radar processor 834 may be configured to utilize MIMO techniques, for example, to support a reduced physical array aperture, e.g., an array size, and/or utilizing a reduced number of antenna elements. For example, radar frontend 804 and/or radar processor 834 may be configured to transmit orthogonal signals via one or more Tx arrays 824 including a plurality of N elements, e.g., Tx antennas 814, and processing received signals via one or more Rx arrays 826 including a plurality of M elements, e.g., Rx antennas 816.

In some demonstrative aspects, utilizing the MIMO technique of transmission of the orthogonal signals from the Tx arrays 824 with N elements and processing the received signals in the Rx arrays 826 with M elements may be equivalent, e.g., under a far field approximation, to a radar utilizing transmission from one antenna and reception with N*M antennas. For example, radar frontend 804 and/or radar processor 834 may be configured to utilize MIMO antenna array 881 as a virtual array having an equivalent array size of N*M, which may define locations of virtual elements, for example, as a convolution of locations of physical elements, e.g., the antennas 814 and/or 816.

In some demonstrative aspects, a radar system may include a plurality of radar devices 800. For example, vehicle 100 (FIG. 1) may include a plurality of radar devices 800, e.g., as described below.

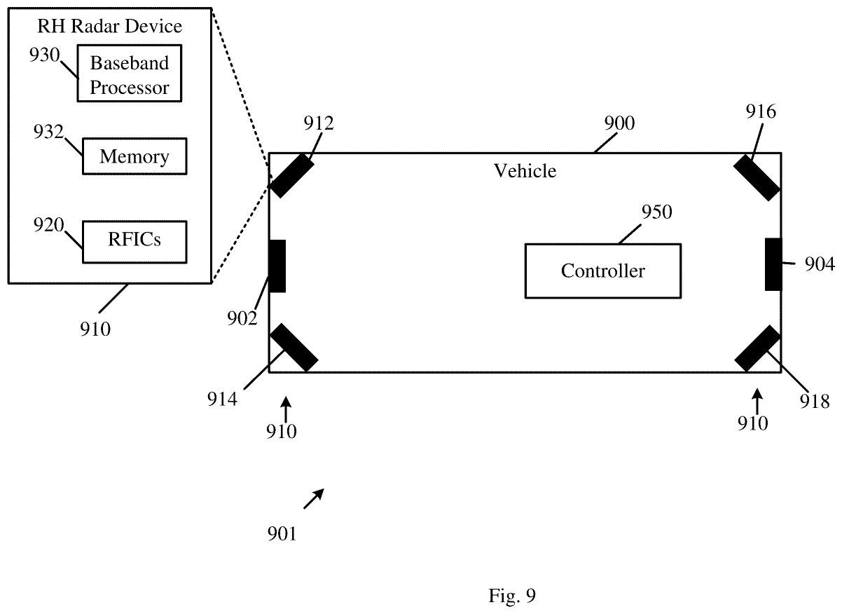

Reference is made to FIG. 9, which schematically illustrates a radar system 901 including a plurality of Radio Head (RH) radar devices (also referred to as RHs) 910 implemented in a vehicle 900, in accordance with some demonstrative aspects.

In some demonstrative aspects, as shown in FIG. 9, the plurality of RH radar devices 910 may be located, for example, at a plurality of positions around vehicle 900, for example, to provide radar sensing at a large field of view around vehicle 900, e.g., as described below.

In some demonstrative aspects, as shown in FIG. 9, the plurality of RH radar devices 910 may include, for example, six RH radar devices 910, e.g., as described below.

In some demonstrative aspects, the plurality of RH radar devices 910 may be located, for example, at a plurality of positions around vehicle 900, which may be configured to support 360-degrees radar sensing, e.g., a field of view of 360 degrees surrounding the vehicle 900, e.g., as described below.

In one example, the 360-degrees radar sensing may allow to provide a radar-based view of substantially all surroundings around vehicle 900, e.g., as described below.

In other aspects, the plurality of RH radar devices 910 may include any other number of RH radar devices 910, e.g., less than six radar devices or more than six radar devices.

In other aspects, the plurality of RH radar devices 910 may be positioned at any other locations and/or according to any other arrangement, which may support radar sensing at any other field of view around vehicle 900, e.g., 360-degrees radar sensing or radar sensing of any other field of view.

In some demonstrative aspects, as shown in FIG. 9, vehicle 900 may include a first RH radar device 902, e.g., a front RH, at a front-side of vehicle 900.

In some demonstrative aspects, as shown in FIG. 9, vehicle 900 may include a second RH radar device 904, e.g., a back RH, at a back-side of vehicle 900.

In some demonstrative aspects, as shown in FIG. 9, vehicle 900 may include one or more of RH radar devices at one or more respective corners of vehicle 900. For example, vehicle 900 may include a first corner RH radar device 912 at a first corner of vehicle 900, a second corner RH radar device 914 at a second corner of vehicle 900, a third corner RH radar device 916 at a third corner of vehicle 900, and/or a fourth corner RH radar device 918 at a fourth corner of vehicle 900.

In some demonstrative aspects, vehicle 900 may include one, some, or all, of the plurality of RH radar devices 910 shown in FIG. 9. For example, vehicle 900 may include the front RH radar device 902 and/or back RH radar device 904.

In other aspects, vehicle 900 may include any other additional or alternative radar devices, for example, at any other additional or alternative positions around vehicle 900. In one example, vehicle 900 may include a side radar, e.g., on a side of vehicle 900.

In some demonstrative aspects, as shown in FIG. 9, vehicle 900 may include a radar system controller 950 configured to control one or more, e.g., some or all, of the RH radar devices 910.

In some demonstrative aspects, at least part of the functionality of radar system controller 950 may be implemented by a dedicated controller, e.g., a dedicated system controller or central controller, which may be separate from the RH radar devices 910, and may be configured to control some or all of the RH radar devices 910.

In some demonstrative aspects, at least part of the functionality of radar system controller 950 may be implemented as part of at least one RH radar device 910.

In some demonstrative aspects, at least part of the functionality of radar system controller 950 may be implemented by a radar processor of an RH radar device 910. For example, radar processor 834 (FIG. 8) may include one or more elements of radar system controller 950, and/or may perform one or more operations and/or functionalities of radar system controller 950.

In some demonstrative aspects, at least part of the functionality of radar system controller 950 may be implemented by a system controller of vehicle 900. For example, vehicle controller 108 (FIG. 1) may include one or more elements of radar system controller 950, and/or may perform one or more operations and/or functionalities of radar system controller 950.

In other aspects, one or more functionalities of system controller 950 may be implemented as part of any other element of vehicle 900.

In some demonstrative aspects, as shown in FIG. 9, an RH radar device 910 of the plurality of RH radar devices 910, may include a baseband processor 930 (also referred to as a “Baseband Processing Unit (BPU)”), which may be configured to control communication of radar signals by the RH radar device 910, and/or to process radar signals communicated by the RH radar device 910. For example, baseband processor 930 may include one or more elements of radar processor 834 (FIG. 8), and/or may perform one or more operations and/or functionalities of radar processor 834 (FIG. 8).

In other aspects, an RH radar device 910 of the plurality of RH radar devices 910 may exclude one or more, e.g., some or all, functionalities of baseband processor 930. For example, controller 950 may be configured to perform one or more, e.g., some or all, functionalities of the baseband processor 930 for the RH.

In one example, controller 950 may be configured to perform baseband processing for all RH radar devices 910, and all RH radio devices 910 may be implemented without baseband processors 930.

In another example, controller 950 may be configured to perform baseband processing for one or more first RH radar devices 910, and the one or more first RH radio devices 910 may be implemented without baseband processors 930; and/or one or more second RH radar devices 910 may be implemented with one or more functionalities, e.g., some or all functionalities, of baseband processors 930.

In another example, one or more, e.g., some or all, RH radar devices 910 may be implemented with one or more functionalities, e.g., partial functionalities or full functionalities, of baseband processors 930.

In some demonstrative aspects, baseband processor 930 may include one or more components and/or elements configured for digital processing of radar signals communicated by the RH radar device 910, e.g., as described below.

In some demonstrative aspects, baseband processor 930 may include one or more FFT engines, matrix multiplication engines, DSP processors, and/or any other additional or alternative baseband, e.g., digital, processing components.

In some demonstrative aspects, as shown in FIG. 9, RH radar device 910 may include a memory 932, which may be configured to store data processed by, and/or to be processed by, baseband processor 930. For example, memory 932 may include one or more elements of memory 838 (FIG. 8), and/or may perform one or more operations and/or functionalities of memory 838 (FIG. 8).

In some demonstrative aspects, memory 932 may include an internal memory, and/or an interface to one or more external memories, e.g., an external Double Data Rate (DDR) memory, and/or any other type of memory.

In other aspects, an RH radar device 910 of the plurality of RH radar devices 910 may exclude memory 932. For example, the RH radar device 910 may be configured to provide radar data to controller 950, e.g., in the form of raw radar data.

In some demonstrative aspects, as shown in FIG. 9, RH radar device 910 may include one or more RF units, e.g., in the form of one or more RF Integrated Chips (RFICs) 920, which may be configured to communicate radar signals, e.g., as described below.

For example, an RFIC 920 may include one or more elements of front-end 804 (FIG. 8), and/or may perform one or more operations and/or functionalities of front-end 804 (FIG. 8).

In some demonstrative aspects, the plurality of RFICs 920 may be operable to form a radar antenna array including one or more Tx antenna arrays and one or more Rx antenna arrays.

For example, the plurality of RFICs 920 may be operable to form MIMO radar antenna 881 (FIG. 8) including Tx arrays 824 (FIG. 8), and/or Rx arrays 826 (FIG. 8).

In some demonstrative aspects, a radar device, e.g., as described above with reference to FIGS. 1-9, may be configured to implement one or more operations and/or functionalities of an interference mitigation mechanism, which may be configured to provide a technical solution to support mitigation of an interferer signal, e.g., as described below.

In some demonstrative aspects, a radar device, e.g., as described above with reference to FIGS. 1-9, may be configured to implement one or more operations and/or functionalities of an interference mitigation mechanism, which may be configured to control a polarization for an antenna, for example, to mitigate an interferer signal, e.g., as described below.

In some demonstrative aspects, a radar device, e.g., as described above with reference to FIGS. 1-9, may be configured to implement one or more operations and/or functionalities of an interference mitigation mechanism, which may be configured to provide a technical solution to support mitigation of an interferer signal, for example, based on controlling a polarization for an antenna. For example, the antenna may be implemented, for example, as part of a variable polarization system, e.g., as described below.

In some demonstrative aspects, a radar device, e.g., as described above with reference to FIGS. 1-9, may be configured to implement one or more operations and/or functionalities of an interference mitigation mechanism, which may be configured to provide a technical solution to support mitigation of a dominant interferer signal, which may cause saturation of receive circuitry of the radar device, and/or may cause a large degradation in Signal to Interference Noise Ratio (SINR) performance of the radar device, e.g., as described below.

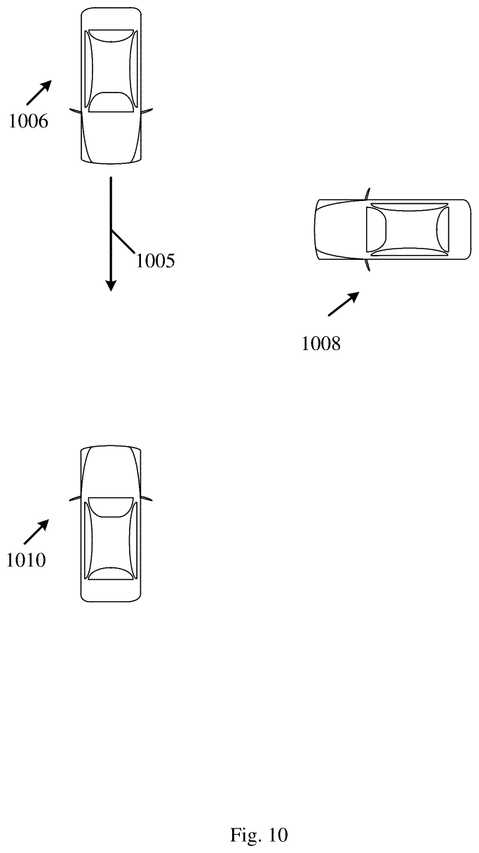

Reference is made to FIG. 10, which schematically illustrates an interference scenario 1000 to demonstrate a technical aspect, which may be addressed in accordance with some demonstrative aspects.

In one example, as shown in FIG. 10, an interferer radar signal 1005 from a front radar of a vehicle 1006 may cause interference to, e.g., may “blind”, a front radar of a vehicle 1010. According to this example, the front radar of the vehicle 1010 may not be able to detect an approaching target vehicle 1008.

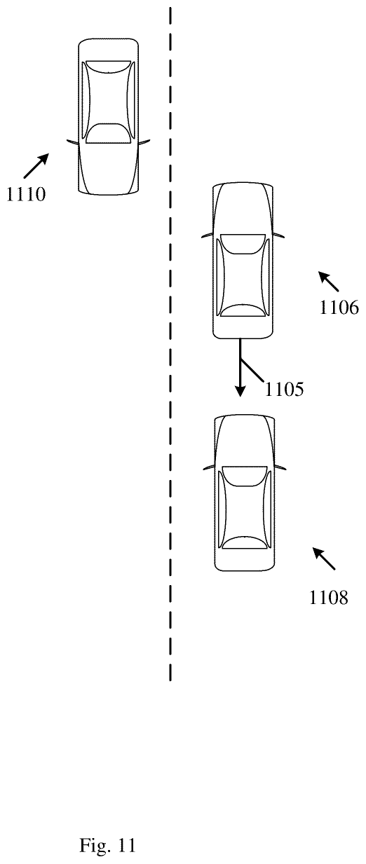

Reference is made to FIG. 11, which schematically illustrates an interference scenario 1100 to demonstrate a technical aspect, which may be addressed in accordance with some demonstrative aspects.

In one example, as shown in FIG. 11, an interferer radar signal 1105 from a back radar of a vehicle 1106 may cause interference to, e.g., may “blind”, a front radar of a vehicle 1108. According to this example, the front radar of the vehicle 1108 may not be able to detect an approaching vehicle 1110 in an adjacent lane. For example, the vehicle 1108 may not be aware of the approaching vehicle 1110, and may attempt to bypass the vehicle 1106 by moving into the adjacent lane, which may actually be occupied by the approaching vehicle 1110.

In some demonstrative aspects, a radar device, e.g., as described above with reference to FIGS. 1-9, may be configured to implement one or more operations and/or functionalities of an interference mitigation mechanism, which may be configured to provide a technical solution to address one or more technical issues of one or more resource-collaboration schemes, for example, to mitigate an interferer signal, e.g., the interferer radar signal 1005 (FIG. 10) and/or the interferer radar signal 1105 (FIG. 11), e.g., as described below.

In some demonstrative aspects, there may be one or more technical problems, disadvantages, and/or inefficiencies in implementation of one or more resource-collaboration schemes, for example, to mitigate interfering signals.

In one example, implementation of the resource-collaboration schemes may require industry level alignment and collaboration, which may be complicated or even impossible to achieve.

In another example, in some cases and/or scenarios, time-frequency collaboration schemes may not be effective, for example, in case an entire frequency spectrum and time slots may be allocated, for example, in scenarios including a high number of units per vehicle with constantly growing requirements.

In some demonstrative aspects, a radar device, e.g., as described above with reference to FIGS. 1-9, may be configured to implement one or more operations and/or functionalities of an interference mitigation mechanism, which may be configured to provide a technical solution to mitigate an interferer signal, e.g., the interferer radar signal 1005 (FIG. 10) and/or the interferer radar signal 1105 (FIG. 11), for example, based on a polarization for an antenna of the radar device, e.g., as described below.

In some demonstrative aspects, a radar device, e.g., as described above with reference to FIGS. 1-9, may be configured to implement one or more operations and/or functionalities of an interference mitigation mechanism, which may be configured to provide a technical solution to address one or more technical issues of a fixed polarity-based scheme for mitigation of an interferer signal, e.g., as described below.

For example, the fixed polarity-based scheme may be configured to change a boresight-polarization at a boresight of an antenna to a polarization, which is substantially opposite to a polarization of an interferer signal.

In one example, the boresight polarization may only be suitable for the boresight. According to this example, the boresight polarization may only be suitable for mitigating interference of an interferer, which is located in a direction of the boresight of the antenna.

In another example, there may be a dependency between an observation angle of the antenna and the polarization tuning of the antenna. Accordingly, the boresight polarization may be less effective with respect to an interferer, which is located at a wide spatial angle, e.g., at a large angular-distance from the boresight of the antenna.

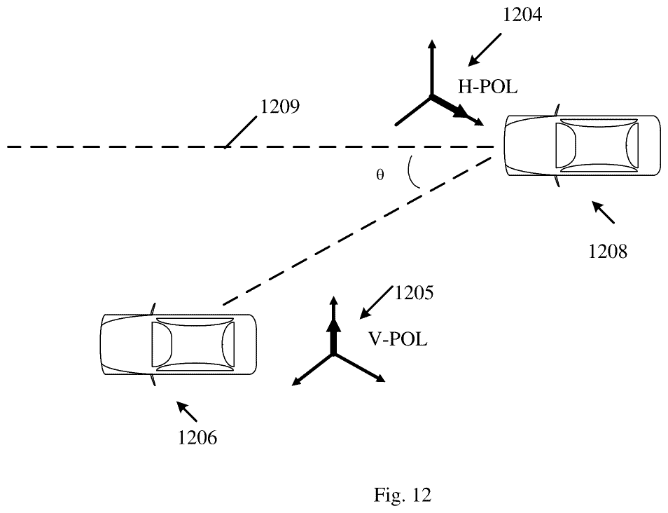

Reference is made to FIG. 12, which schematically illustrates an interference scenario 1200 to demonstrate a technical aspect, which may be addressed in accordance with some demonstrative aspects.

In one example, as shown in FIG. 12, an interferer radar signal 1205 from a back radar of a vehicle 1206 may have a vertical polarization.

In one example, as shown in FIG. 12, the interferer radar signal 1205 may cause interference to, e.g., may “blind”, a front radar of a vehicle 1208.

For example, implementing the fixed polarity-based scheme may allow the front radar of the vehicle 1208 to communicate radar signals 1204 with a fixed horizontal polarization, e.g., at a boresight 1209 of the front radar, for example, to avoid saturation of the receiver of the front radar of vehicle 1208, e.g., due to an interferer radar at the boresight direction 1209.

However, the fixed horizontal polarization at the boresight 1209 may not be suitable for handling the interferer radar signal 1205 at the direction of the vehicle 1206.

For example, as shown in FIG. 12, the interferer radar signal 1205 from vehicle 1206 may be at an angle, denoted θ, e.g., a wide-angle of about 50 degrees, relative to the boresight 1209.

According to this example, the fixed horizontal polarization at the boresight 1209 may be less effective for the interferer radar signal 1205 at the angle θ, for example, due to a dependency between the angle θ and the polarization tuning of the antenna.

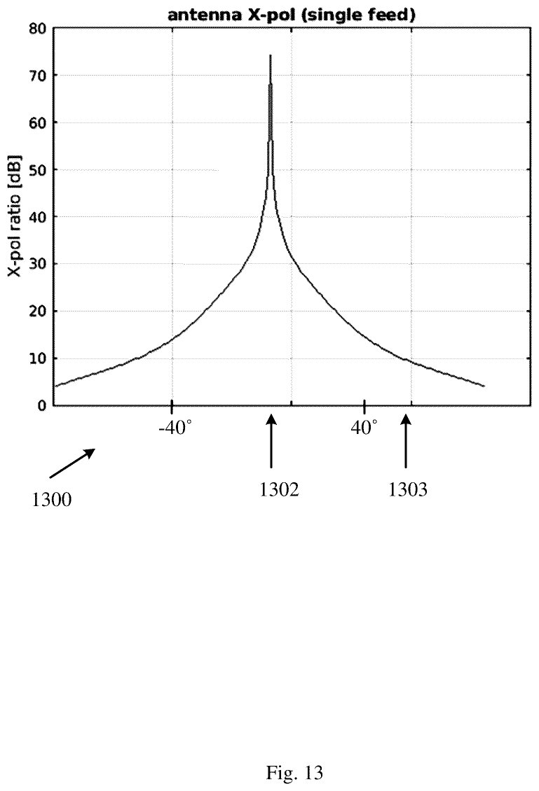

Reference is made to FIG. 13, which schematically illustrates a graph 1300 depicting a cross-polarization (Xpol) ratio of an antenna as a function of an angle to demonstrate a technical aspect, which may be addressed in accordance with some demonstrative aspects.

In one example, the Xpol ratio of the antenna corresponding to a particular azimuth angle may include a ratio between a co-polarization of the antenna corresponding to the particular azimuth angle and a cross-polarization of the antenna corresponding to the particular azimuth angle.

In one example, graph 1300 depicts the Xpol ratio of a patch antenna.

In one example, graph 1300 may represent the Xpol ratio of an antenna of the front radar of the vehicle 1208 (FIG. 12).

As shown in FIG. 13, the Xpol ratio at a boresight 1302 of the antenna may be relatively high, e.g., above 70 dB.

As shown in FIG. 13, there may be a dependency between the azimuth angle and the Xpol ratio. For example, the Xpol ratio may decrease with an increase of the azimuth angle relative to the boresight 1302.

As shown in FIG. 13, the Xpol ratio may be less than 15 dB, e.g., at azimuth angles beyond ±40°.

As shown in FIG. 13, the Xpol ratio may be less than 11 dB, for example, at an azimuth angle 1303, e.g., an angle of about 50°, which corresponds to the angle θ of interferer radar signal 1205 (FIG. 12).

For example, the Xpol ratio at the azimuth angle 1303 may not support an efficient mitigation of the interferer signal 1205 (FIG. 12) at the front radar of the vehicle 1208 (FIG. 12).

In some demonstrative aspects, a relation between the Xpol ratio of an antenna and a spatial angle, e.g., the azimuth angle, may apply to both an Rx path and a Tx path of the antenna.

In some demonstrative aspects, a radar device, e.g., as described above with reference to FIGS. 1-9, may be configured to implement one or more operations and/or functionalities of an interference mitigation mechanism, which may be configured to provide a technical solution to support mitigation of an interferer signal, e.g., a dominant interferer signal, for example, based on angle-based information, which may be based on an angle of the interferer signal relative to a boresight of an antenna, e.g., as described below.

In some demonstrative aspects, a radar device, e.g., as described above with reference to FIGS. 1-9, may be configured to implement one or more operations and/or functionalities of an interference mitigation mechanism, which may be configured to provide a technical solution to support mitigation of an interferer signal, for example, by determining a source polarization of the interferer signal, and dynamically transmitting and/or receiving at an angle of the interferer signal in a polarity, which may be orthogonal to a source polarity of the interferer signal, e.g., as described below.

In some demonstrative aspects, a radar device, e.g., as described above with reference to FIGS. 1-9, may be configured to implement one or more operations and/or functionalities of an interference mitigation mechanism, which may be configured to control a polarization setting of an antenna, for example, based on an angle of the interferer signal, e.g., as described below.

In some demonstrative aspects, the interference mitigation mechanism may be configured to provide a technical solution to support mitigation of an interferer signal, for example, even without requiring industry level alignment and/or collaboration, e.g., as described below.

In some demonstrative aspects, the interference mitigation mechanism may be configured to provide a technical solution to support mitigation of an interferer signal, which may not be located at a boresight angle of the antenna, e.g., nulling of an off-boresight interferer, for example, with enhanced efficiency and/or performance, e.g., as described below.

In some demonstrative aspects, the interference mitigation mechanism may be configured to provide a technical solution to support reducing interference to an environment, for example, by configuring a transmitter to transmit signals with a cross polarization with respect to a polarization of a close interferer signal. For example, this configuration may reduce interference to a legacy unit.

In some demonstrative aspects, the interference mitigation mechanism may be configured to provide a technical solution to reduce, e.g., eliminate, interference to a radar device, e.g., radar device 800 (FIG. 8), by other adjacent vehicles.

In some demonstrative aspects, the interference mitigation mechanism may be configured to provide a technical solution to reduce a dynamic range utilization of a receive path, e.g., an analog receive path and/or a digital receive path, for example, by preventing saturation of the receive path.

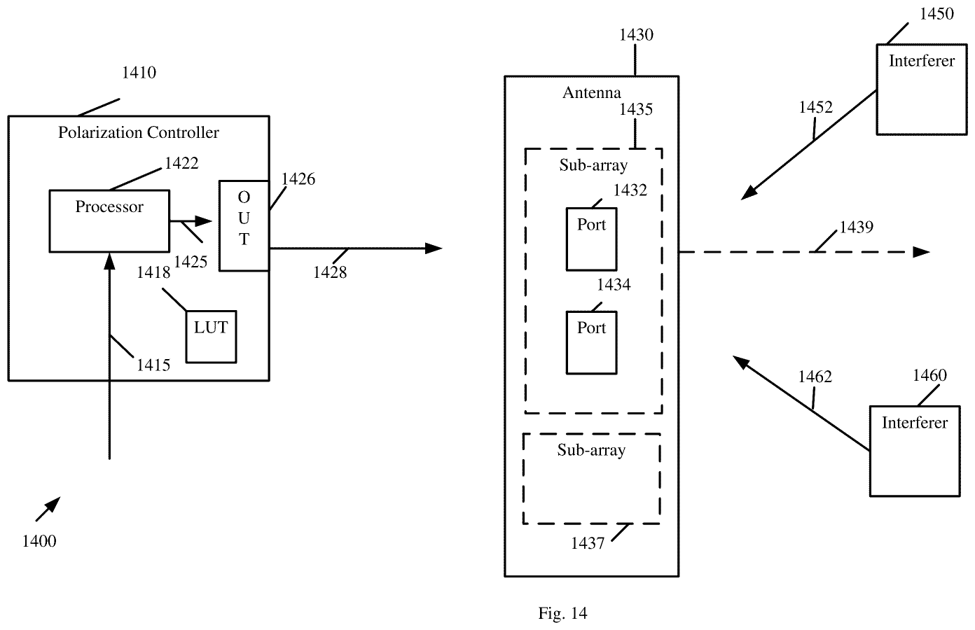

Reference is made to FIG. 14, which schematically illustrates a system 1400, in accordance with some demonstrative aspects.

In some demonstrative aspects, one or more components of system 1400 may be implemented as part of a radar device. For example, radar device 800 (FIG. 8) may include one or more element of system 1400, and/or may perform one or more operations and/or functionalities of system 1400.

In some demonstrative aspects, system 1400 may be implemented as part of any other suitable device and/or system.

For example, in some demonstrative aspects, system 1400 may be implemented as part of a device, for example, a mobile device, a computing device, and/or a wireless communication device, for example, to communicate RF wireless communication signals.

For example, in some demonstrative aspects, system 1400 may be implemented to communicate the RF wireless communication signals over millimeter wave (mmWave) frequencies and/or any other suitable frequencies.

In some demonstrative aspects, system 1400 may include polarization controller 1410, which may be configured to control a polarization for an antenna 1430, e.g., as described below.

In some demonstrative aspects, polarization controller 1410 may include a processor 1422, e.g., as described below.

In some demonstrative aspects, processor 1422 may be configured to process interference information 1415, for example, to identify angle-based information, which may be based, for example, on an angle of an interferer signal 1452 relative to a boresight 1439 of the antenna 1430, e.g., as described below.

In some demonstrative aspects, interferer signal 1452 may be transmitted from an interferer 1450.

In some demonstrative aspects, processor 1422 may be configured to determine a polarization setting 1425 of the antenna 1430, for example, based on the angle-based information, e.g., as described below.

In some demonstrative aspects, polarization controller 1410 may include an output 1426 to provide a control output 1428, for example, to control the polarization for the antenna 1430, for example, based on the polarization setting 1425, e.g., as described below.

In some demonstrative aspects, output 1426 may include any suitable output interface, output unit, output module, output component, output circuitry, memory interface, memory access unit, memory writer, digital memory unit, bus interface, processor interface, or the like, which may be capable of outputting the control output 1428 to a memory, a processor, and/or any other suitable component to handle the control output 1428.

In some demonstrative aspects, the polarization setting 1425 of the antenna 1430 may include a phase setting, e.g., as described below.

In some demonstrative aspects, the polarization setting 1425 of the antenna 1430 may include an amplitude setting, e.g., as described below.

In some demonstrative aspects, the polarization setting 1425 of the antenna 1430 may include an Rx polarization setting 1425, for example, to receive an Rx signal via the antenna 1430, e.g., as described below.

In some demonstrative aspects, the polarization setting 1425 of the antenna 1430 may include a Tx polarization setting 1425, for example, to receive a Tx signal via the antenna 1430, e.g., as described below.

In some demonstrative aspects, the polarization setting 1425 of the antenna 1430 may include a first setting for a Horizontal-polarization (H-pol) port 1432 of the antenna 1430, e.g., as described below.

In some demonstrative aspects, the polarization setting 1425 of the antenna 1430 may include a second setting for a Vertical-polarization (V-pol) port 1434 of the antenna 1430, e.g., as described below.

In other aspects, the polarization setting 1425 of the antenna 1430 may include any other additional and/or alternative setting.

In some demonstrative aspects, processor 1422 may be configured to determine a first polarization setting 1425 of the antenna 1430, for example, based on first angle-based information, which may be based on the angle of the interferer signal 1452, e.g., as described below.

In some demonstrative aspects, processor 1422 may be configured to determine a second polarization setting 1425 of the antenna 1430, for example, based on second angle-based information, which may be based on the angle of the interferer signal 1452, e.g., as described below.

In some demonstrative aspects, the first angle-based information may be different from the second angle-based information, and the first polarization setting 1425 may be different from the second polarization setting 1425, e.g., as described below.

In some demonstrative aspects, processor 1422 may be configured to identify first angle-based information, which may be based on a first angle of a first interferer signal, e.g., interferer signal 1452, relative to the boresight 1439 of the antenna 1430, e.g., as described below.

In some demonstrative aspects, processor 1422 may be configured to determine a first polarization setting 1425 of the antenna 1430, for example, based on the first angle-based information corresponding to the first interferer signal, e.g., as described below.

In some demonstrative aspects, processor 1422 may be configured to identify second angle-based information, which may be based on a second angle of a second interferer signal 1462, e.g., from an interferer 1460, relative to the boresight 1439 of the antenna 1430, e.g., as described below.

In some demonstrative aspects, processor 1422 may be configured to determine a second polarization setting 1425 of the antenna 1430, for example, based on the second angle-based information corresponding to the second interferer signal, e.g., as described below.

In some demonstrative aspects, the first polarization setting 1425 corresponding to the first interferer signal may be different from the second polarization setting 1425 corresponding to the second interferer signal, e.g., as described below.

In some demonstrative aspects, the first angle-based information corresponding to the first interferer signal may be different from the second angle-based information corresponding to the second interferer signal, e.g., as described below.

In some demonstrative aspects, the first angle of the first interferer signal 1452 relative to the boresight 1439 of the antenna 1430 may be different from the second angle of the second interferer signal 1462 relative to the boresight 1439 of the antenna 1430, e.g., as described below.

In some demonstrative aspects, processor 1422 may be configured to determine the polarization setting 1425 of the antenna 1430 based on the angle-based information, for example, such that an Xpol ratio at the angle of the interferer signal 1452 may be at least 20 decibel (dB), e.g., as described below.

In some demonstrative aspects, the Xpol ratio at the angle of the interferer signal 1452 may include, for example, a ratio between a co-polarization of the antenna 1430 at the angle of the interferer signal 1452, and a cross-polarization of the antenna 1430 at the angle of the interferer signal 1452, e.g., as described below.

In some demonstrative aspects, processor 1422 may be configured to determine the polarization setting 1425 of the antenna 1430, for example, based on the angle-based information, for example, such that the Xpol ratio at the angle of the interferer signal 1452 may be between 20 dB and 55 dB, e.g., as described below.

In some demonstrative aspects, processor 1422 may be configured to determine the polarization setting 1425 of the antenna 1430 based on the angle-based information, for example, such that the Xpol ratio at the angle of the interferer signal 1452 may be at least 30 dB, e.g., as described below.

In some demonstrative aspects, processor 1422 may be configured to determine the polarization setting 1425 of the antenna 1430 based on the angle-based information, for example, such that the Xpol ratio at the angle of the interferer signal 1452 may be at least 40 dB, e.g., as described below.

In some demonstrative aspects, processor 1422 may be configured to determine the polarization setting 1425 of the antenna 1430 based on the angle-based information, for example, such that the Xpol ratio at the angle of the interferer signal 1452 may be at least 50 dB, e.g., as described below.

In other aspects, processor 1422 may be configured to determine the polarization setting 1425 of the antenna 1430, for example, to achieve any other suitable Xpol ratio at the angle of the interferer signal 1452.

In some demonstrative aspects, processor 1422 may be configured to determine the polarization setting 1425 of the antenna 1430 to include a first polarization setting 1425, for example, prior to identifying the angle-based information corresponding to the interferer signal 1452, e.g., as described below.

In some demonstrative aspects, processor 1422 may be configured to determine the polarization setting 1425 of the antenna 1430 to include a second polarization setting 1425, for example, based on the angle-based information corresponding to the interferer signal 1452, e.g., as described below.

In some demonstrative aspects, an Xpol ratio at the angle of the interferer signal 1452 according to the second polarization setting 1425 may be, for example, greater than an Xpol ratio at the angle of the interferer signal 1452 according to the first polarization setting 1425, e.g., as described below.

In some demonstrative aspects, processor 1422 may be configured to process the interference information 1415, for example, to identify the angle of the interferer signal 1452 relative to the boresight 1439 of the antenna 1430, e.g., as described below.

In some demonstrative aspects, processor 1422 may be configured to determine the polarization setting 1425 of the antenna 1430, for example, based on the angle of the interferer signal 1452 relative to the boresight 1439 of the antenna 1430, e.g., as described below.

In some demonstrative aspects, processor 1422 may be configured to retrieve the polarization setting 1425 of the antenna 1430 from a Look Up Table (LUT) 1418, for example, based on the angle of the interferer signal 1452, e.g., as described below.

In some demonstrative aspects, the LUT 1418 may include a plurality of predefined polarization settings corresponding to a plurality of predefined angles, e.g., as described below.

In some demonstrative aspects, processor 1422 may be configured to identify first angle-based information, which may be based on a first angle of a first interferer signal, e.g., interferer signal 1452, relative to the boresight 1439 of the antenna 1430, e.g., as described below.

In some demonstrative aspects, processor 1422 may be configured to identify second angle-based information, which may be based on a second angle of a second interferer signal 1462, e.g., from interferer 1460, relative to the boresight 1439 of the antenna 1430, e.g., as described below.

In some demonstrative aspects, processor 1422 may be configured to determine the polarization setting 1425 of the antenna 1430, for example, based on the first angle-based information and the second angle-based information, e.g., as described below.

In some demonstrative aspects, processor 1422 may be configured to determine a first polarization setting 1425 of a first sub-array 1435 of the antenna 1430, for example, based on the first angle-based information, which may be based on the first angle of the first interferer signal 1452 relative to the boresight 1439 of the antenna 1430, e.g., as described below.

In some demonstrative aspects, processor 1422 may be configured to determine a second polarization setting 1425 of a second sub-array 1437 of the antenna 1430, for example, based on the second angle-based information, which may be based on the second angle of the second interferer signal 1462 relative to the boresight 1439 of the antenna 1430, e.g., as described below.

In some demonstrative aspects, a Field of View (FoV) of the first sub-array 1435 may include the first angle of the first interferer signal 1452, and may not include, for example, the second angle of the second interferer signal 1462, e.g., as described below.

In some demonstrative aspects, a FoV of the second sub-array 1437 may include the second angle of the second interferer signal 1462, and may not include, for example, the first angle of the first interferer signal 1452, e.g., as described below.

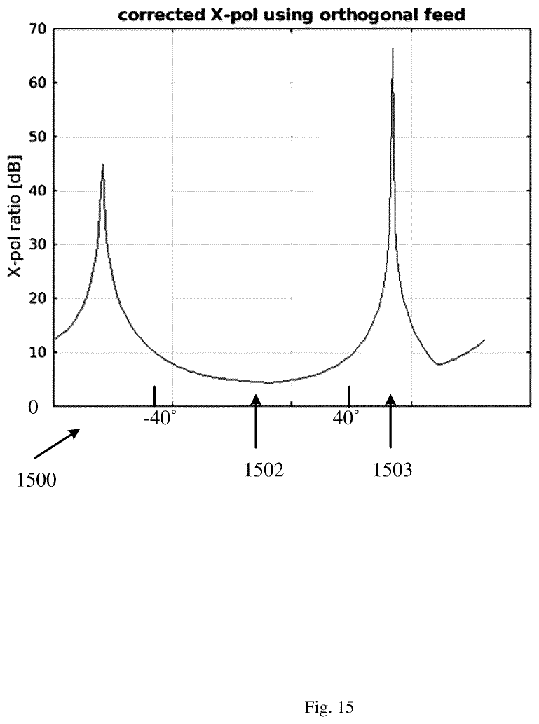

Reference is made to FIG. 15, which schematically illustrates a graph 1500 depicting an Xpol ratio of an antenna as a function of an angle, in accordance with some demonstrative aspects.

In one example, graph 1500 depicts the Xpol ratio of the patch antenna array of FIG. 13, for example, when configured according to a polarization setting, which may be determined, for example, based on angle-based information of an interferer signal, e.g., as described above.

For example, graph 1500 may represent the Xpol ratio of antenna 1430 (FIG. 14), for example, an antenna of the front radar of the vehicle 1208 (FIG. 12), for example, according to a polarization setting, which may be determined by processor 1422 (FIG. 14), for example, based on angle-based information, which may be based on the angle θ of interferer radar signal 1205 (FIG. 12).

In some demonstrative aspects, as shown in FIG. 15, the Xpol ratio of the antenna at a boresight 1502 of the antenna may be less than 10 db.

In some demonstrative aspects, as shown in FIG. 15, the Xpol ratio of the antenna at an angle 1503, e.g., an angle of about 50 degrees, corresponding to the interferer radar signal 1205 (FIG. 12) may be relatively high, e.g., above 60 dB.

In some demonstrative aspects, the processor 1422 (FIG. 14) may be configured to determine the polarization setting of the antenna, for example, such that the Xpol ratio at the angle of interferer radar signal 1205 (FIG. 12), e.g., angle 1503, may be at least 50 dB, for example, to provide a technical solution to support mitigation of the interference from the interferer radar signal 1205 (FIG. 12).

Referring back to FIG. 10, in some demonstrative aspects, processor 1422 may be configured to determine the polarization setting 1425 of the antenna 1430, for example, such that the polarization setting 1425 of the antenna 1430 may be substantially orthogonal to a polarization of the interferer signal 1452, e.g., as described below.

In some demonstrative aspects, processor 1422 may be configured to determine the polarization setting 1425 of the antenna 1430, for example, such that a scalar multiplication (also referred to as a dot product) of the polarization of the interferer signal 1452 with the polarization setting 1425 of the antenna 1430 may be substantially equal to zero.

In some demonstrative aspects, processor 1422 may be configured to process the interference information 1415, for example, to identify a first-polarization component of the interferer signal 1452 and a second-polarization component of the interferer signal 1452, e.g., as described below.

In some demonstrative aspects, the first-polarization component of the interferer signal 1452 may correspond to a first polarization, and the second-polarization component of the interferer signal 1452 may correspond to a second polarization, which may be substantially orthogonal to the first polarization, e.g., as described below.

In some demonstrative aspects, the first-polarization component may include a Vertical-polarization (V-polarization) component corresponding to a V-polarization, e.g., as described below.

In some demonstrative aspects, the second-polarization component may include a Horizontal-polarization (H-polarization) component corresponding to an H-polarization, e.g., as described below.

In other aspects, the first-polarization component and the second-polarization component may correspond to any other suitable configuration and/or definition of first and second polarizations. In one example, the first-polarization component and the second-polarization component may be defined according to a slant polarization scheme, and/or any other suitable polarization scheme.

In some demonstrative aspects, processor 1422 may be configured to determine the polarization setting 1425 of the antenna 1430, for example, based on the first-polarization component and the second-polarization component of the interferer signal 1452, e.g., as described below.

In some demonstrative aspects, processor 1422 may be configured to determine the polarization setting 1425 of the antenna 1430, for example, to include a first-polarization setting 1425 corresponding to the first polarization, and a second-polarization setting 1425 corresponding to the second polarization, e.g., as described below.

In some demonstrative aspects, the first-polarization setting 1425 and the second-polarization setting 1425 may be based, for example, on the first-polarization component and the second-polarization component, e.g., as described below.

In some demonstrative aspects, processor 1422 may be configured to process the interference information 1415, for example, to identify a magnitude of the first-polarization component of the interferer signal 1452, and a magnitude of the second-polarization component of the interferer signal 1452, e.g., as described below.

In some demonstrative aspects, processor 1422 may be configured to determine the polarization setting 1425 of the antenna 1430, for example, based on the magnitude of the first-polarization component and the magnitude of the second-polarization component of the interferer signal 1452, e.g., as described below.

In some demonstrative aspects, processor 1422 may be configured to determine the first-polarization setting 1425 and the second-polarization setting 1425, for example, based on the magnitude of the first-polarization component and the magnitude of the second-polarization component, e.g., as described below.

In some demonstrative aspects, processor 1422 may be configured to determine the first polarization setting 1425 of the antenna 1430 corresponding to the first polarization, for example, based on the magnitude of the second-polarization component of the interferer signal 1452 corresponding to the second polarization, e.g., as described below.

In some demonstrative aspects, processor 1422 may be configured to determine the second polarization setting 1425 of the antenna 1430 corresponding to the second polarization, for example, based on the magnitude of the first-polarization of the interferer signal 1452 corresponding to the first polarization, e.g., as described below.

In some demonstrative aspects, processor 1422 may be configured to determine one of the first and second polarization settings 1425 of the antenna 1430 to include an additive inverse of the magnitude of the corresponding polarization component of the interferer signal 1452, and to determine another one of the first and second polarization settings 1425 of the antenna 1430 to include the magnitude of the corresponding polarization component of the interferer signal 1452, e.g., as described below.

In one example, processor 1422 may be configured to determine the first polarization setting 1425 of the antenna 1430 corresponding to the first polarization, to be equal, for example, to an additive inverse of the magnitude of the second-polarization component of the interferer signal 1452 corresponding to the second polarization, and to determine the second polarization setting 1425 of the antenna 1430 corresponding to the second polarization, to be equal, for example, to the magnitude of the first-polarization component of the interferer signal 1452 corresponding to the first polarization, e.g., as described below.

In another example, processor 1422 may be configured to determine the first polarization setting 1425 of the antenna 1430 corresponding to the first polarization, to be equal, for example, to the magnitude of the second-polarization component of the interferer signal 1452 corresponding to the second polarization, and to determine the second polarization setting 1425 of the antenna 1430 corresponding to the second polarization, to be equal, for example, to an additive inverse of the magnitude of the first-polarization component of the interferer signal 1452 corresponding to the first polarization, e.g., as described below.

In some demonstrative aspects, processor 1422 may be configured to determine the polarization setting 1425 of the antenna 1430, for example, based on a phase shift (also referred to as an “electrical phase shift”) between the first-polarization component and the second-polarization component of the interferer signal 1452, e.g., as described below.

For example, there may be a phase shift (electrical phase shift) between the first-polarization component and the second-polarization component of the interferer signal 1452, e.g., in case the interferer signal 1452 has a circular polarization or an elliptical polarization.

For example, there may be no phase shift (electrical phase shift) between the first-polarization component and the second-polarization component of the interferer signal 1452, e.g., in case the interferer signal 1452 has a linear polarization.

In some demonstrative aspects, processor 1422 may be configured to determine a phase shift (electrical phase shift) between the first-polarization setting 1425 and the second-polarization setting 1425, for example, based on the phase shift (electrical phase shift) between the first-polarization component and the second-polarization component of the interferer signal 1452, e.g., as described below.

In some demonstrative aspects, processor 1422 may be configured to determine the phase shift (electrical phase shift) between the first-polarization setting 1425 and the second-polarization setting 1425, for example, such that the polarization setting 1425 of the antenna 1430 may be substantially orthogonal to the polarization of the interferer signal 1452, e.g., as described below.

In one example, processor 1422 may be configured to determine the phase shift (electrical phase shift) between the first-polarization setting 1425 and the second-polarization setting 1425, for example, such that the polarization setting 1425 of the antenna 1430 may be a right-hand circular or elliptical polarization, for example, in case the interferer signal 1452 has a left-hand circular or elliptical polarization, e.g., as described below.

In one example, processor 1422 may be configured to determine the phase shift (electrical phase shift) between the first-polarization setting 1425 and the second-polarization setting 1425, for example, such that the polarization setting 1425 of the antenna 1430 may be a left-hand circular or elliptical polarization, for example, in case the interferer signal 1452 has a right-hand circular or elliptical polarization, e.g., as described below.

In some demonstrative aspects, processor 1422 may be configured to determine the phase shift (electrical phase shift) between the first-polarization setting 1425 and the second-polarization setting 1425, for example, based on an additive inverse of the phase shift (electrical phase shift) between the first-polarization component and the second-polarization component of the interferer signal 1452, e.g., as described below.

In some demonstrative aspects, processor 1422 may be configured to determine the phase shift (electrical phase shift) between the first-polarization setting 1425 and the second-polarization setting 1425 to be equal, for example, to the additive inverse of the phase shift (electrical phase shift) between the first-polarization component and the second-polarization component of the interferer signal 1452, e.g., as described below.

For example, the interferer signal 1452 may have an elliptical polarization, which may be represented in the form of a\hat{x}+bŷe^{jφ}, wherein a denotes the magnitude of the first-polarization component of the interferer signal 1452 corresponding to the first polarization, denoted \hat{x}, b denotes the magnitude of the second-polarization component of the interferer signal 1452 corresponding to the second polarization, denoted ŷ, and φ denotes the phase difference (electrical phase shift) between the first-polarization component of the interferer signal 1452 and the second-polarization component of the interferer signal 1452.

In one example, processor 1422 may be configured to set the polarization setting 1425 of the antenna 1430 to b\hat{x}−aŷe^{-jφ}, for example, by setting the first-polarization setting to b, the second-polarization setting to (−a), and the phase shift (electrical phase shift) between the first-polarization setting and the second-polarization setting to (−φ).

In another example, processor 1422 may be configured to set the polarization setting 1425 of the antenna 1430 to −b\hat{x}+aŷe^{-jφ}, for example, by setting the first-polarization setting to (−b), the second-polarization setting to a, and the phase shift (electrical phase shift) between the first-polarization setting and the second-polarization setting to (−φ).

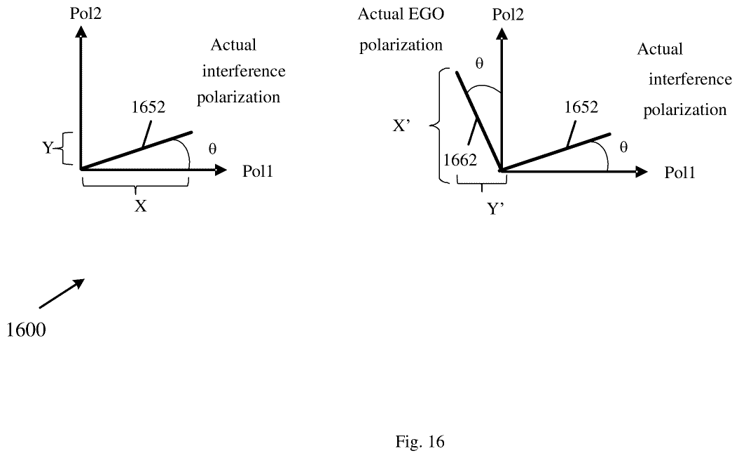

Reference is made to FIG. 16, which schematically illustrates a polarization-setting scheme 1600 to determine a polarization setting of an antenna, in accordance with some demonstrative aspects.

In one example, a processor, e.g., processor 1422 (FIG. 14), may be configured to determine a polarization setting of an antenna, e.g., the polarization setting 1425 (FIG. 14) of the antenna 1430 (FIG. 14), for example, according to the polarization-setting determination scheme 1600.

In some demonstrative aspects, as shown in FIG. 16, the processor, e.g., processor 1422 (FIG. 14), may be configured to process interference information, for example, to identify a magnitude, denoted X, of a first-polarization component of a polarization 1652 of an interferer signal, and a magnitude, denoted Y, of a second-polarization component of the polarization 1652 of the interferer signal.

In some demonstrative aspects, as shown in FIG. 16, the magnitude X of the first-polarization component may correspond to a first polarization axis, denoted Pol1.

In some demonstrative aspects, as shown in FIG. 16, the magnitude Y of the second-polarization component may correspond to a second polarization axis, denoted Pol2, which may be substantially orthogonal to the first polarization axis Pol1.

In some demonstrative aspects, as shown in FIG. 16, the interferer signal may be located at an angle, denoted θ, relative to a boresight of the antenna.

In some demonstrative aspects, as shown in FIG. 16, the processor, e.g., processor 1422 (FIG. 14), may be configured to determine the polarization setting of the antenna, for example, based on the magnitude X of the first-polarization component and the magnitude Y of the second-polarization component, e.g., as described below.

In some demonstrative aspects, as shown in FIG. 16, the processor, e.g., processor 1422 (FIG. 14), may be configured to determine the polarization setting of the antenna, for example, such that a polarization 1662 for the antenna may be substantially orthogonal to the polarization 1652 of the interferer signal.

In some demonstrative aspects, as shown in FIG. 16, the processor, e.g., processor 1422 (FIG. 14), may be configured to determine the polarization setting of the antenna, for example, based on the magnitude X of the first-polarization component of the polarization 1652 with respect to the first polarization axis Pol1, and the magnitude Y of the second-polarization component of the polarization 1652 with respect to the second polarization axis Pol2.

In some demonstrative aspects, the processor, e.g., processor 1422 (FIG. 14), may be configured to determine a first polarization setting of the polarization 1662 corresponding to the polarization axis Pol1, for example, based on the magnitude Y of the second-polarization component of the polarization 1652 with respect to the second polarization axis Pol2, e.g., as described below.

In some demonstrative aspects, the processor, e.g., processor 1422 (FIG. 14), may be configured to determine a second polarization setting of the polarization 1662 corresponding to the polarization axis Pol2, for example, based on the magnitude X of the first-polarization component of the polarization 1652 with respect to the second polarization axis Pol1, e.g., as described below.

In one example, as shown in FIG. 16, the polarization 1662 may be configured to include a cross polarization to the polarization 1652 of the interference signal, for example, such that the polarization 1662 may have a magnitude X′, e.g., X′=X, on the polarization axis Pol2 and a magnitude Y′, e.g., Y′=(−Y) on the polarization axis Pol1. For example, this polarization setting of polarization 1662 may be in cross-polarization to the polarization 1652, for example, such that an elimination of the undesired interference signal may utilize an inversion of one of the polarization components of the polarization 1652.

In another example, the polarization 1662 may be formed based on a combination of a polarization magnitude Y on the polarization axis Pol1 and a polarization magnitude (−X) on the polarization axis Pol2. For example, this polarization setting may be in cross-polarization to the polarization 1652, for example, such that an elimination of the undesired interference signal may utilize an inversion of one of the polarization components of the polarization 1652.

In some demonstrative aspects, as shown in FIG. 16, the processor, e.g., processor 1422 (FIG. 14), may be configured to determine the polarization setting of the antenna, for example, such that the polarization 1662 for the antenna at the angle θ of the interferer signal may be substantially orthogonal to the polarization 1652 of the interferer signal.

In some demonstrative aspects, the processor, e.g., processor 1422 (FIG. 14), may be configured to replace between coefficients of the magnitude X and the magnitude Y of the polarization 1652 of the interferer signal, for example, using proper 0°/180° phases, for example, to eliminate an undesired cross polarization component.

For example, the processor, e.g., processor 1422 (FIG. 14), may be configured to set a first-polarization magnitude of a transmitted signal via the H-pol port 1432 (FIG. 14) to X, and to set a second-polarization magnitude of a transmitted signal via the V-pol port 1434 (FIG. 14) to Y, for example, based on a determination that a polarization magnitude of an interferer signal received via the H-pol port 1432 (FIG. 14) is Y, and a polarization magnitude of the interferer signal received via the V-pol port 1434 (FIG. 14) is X.

In one example, the magnitude X of the first-polarization component of the polarization 1652 of the interferer signal may be 0.9, e.g., H-pol=0.9, and the magnitude Y of the second-polarization component of the polarization 1652 of the interferer signal may be 0.1 e.g., V-pol=0.1. According to this example, the processor, e.g., processor 1422 (FIG. 14), may be configured to set the first-polarization for the H-pol port 1432 (FIG. 14) of the antenna to −0.1, e.g., H-pol=−0.1, and to set the second-polarization for the V-pol port 1434 (FIG. 14) of the antenna to 0.9, e.g., V-pol=0.9. Alternatively, the processor, e.g., processor 1422 (FIG. 14), may be configured to set the first-polarization for the H-pol port 1432 (FIG. 14) of the antenna to 0.1, e.g., H-pol=0.1, and the second-polarization for the V-pol port 1434 (FIG. 14) of the antenna to −0.9, e.g., V-pol=−0.9.

In another example, the magnitude X of the first-polarization component of the polarization 1652 of the interferer signal may be −0.9, e.g., H-pol=−0.9, and the magnitude Y of the first-polarization component of the polarization 1652 of the interferer signal may be 0.1, e.g., V-pol=0.1. According to this example, the processor, e.g., processor 1422 (FIG. 14), may be configured to set the first-polarization for the H-pol port 1432 (FIG. 14) of the antenna to 0.1, e.g., H-pol=0.1, and to set the second-polarization for the V-pol port 1434 (FIG. 14) of the antenna to −0.9, e.g., V-pol=−0.9. Alternatively, the processor, e.g., processor 1422 (FIG. 14), may be configured to set the first-polarization for the H-pol port 1432 (FIG. 14) of the antenna to −0.1, e.g., H-pol=−0.1, and to set the second-polarization for the V-pol port 1434 (FIG. 14) of the antenna to 0.9, e.g., V-pol=0.9.

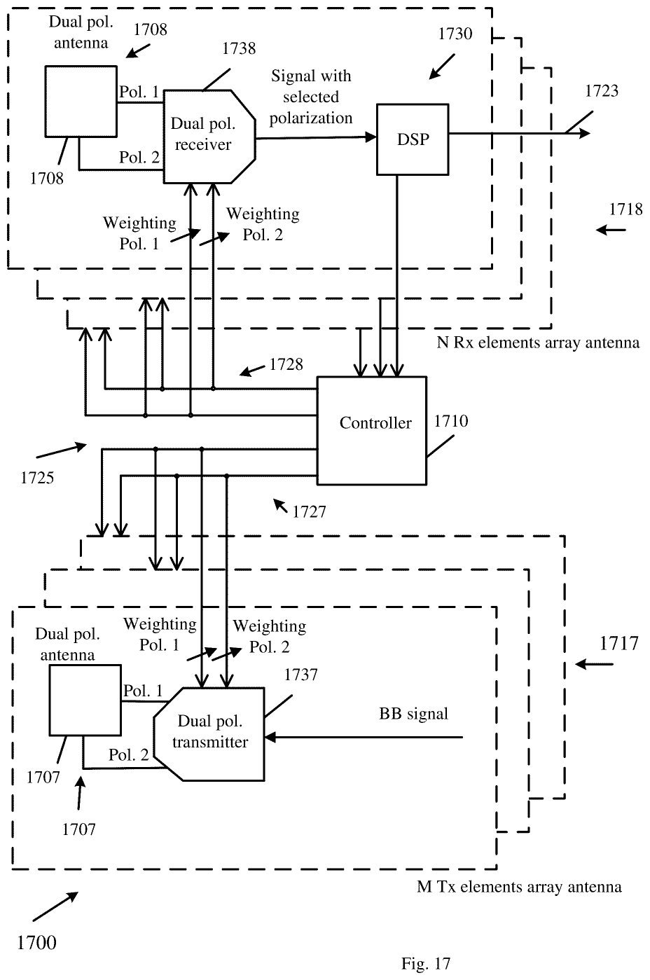

Reference is made to FIG. 17, which schematically illustrates a system 1700, in accordance with some demonstrative aspects. For example, system 1400 (FIG. 14) may include one or more elements of system 1700, and/or may perform one or more operations and/or functionalities of system 1700.

In some demonstrative aspects, as shown in FIG. 17, system 1700 may include a plurality of Tx antennas 1707 connected to a plurality of Tx chains 1717, e.g., as described below.

In some demonstrative aspects, as shown in FIG. 17, system 1700 may include a plurality of Rx antennas 1708 connected to a plurality of Rx chains 1718, e.g., as described below.

In some demonstrative aspects, as shown in FIG. 17, system 1700 may include a processor 1730, e.g., a radar processor, which may be configured to generate radar information 1723, for example, based on radar Rx signals processed by the plurality of Rx chains 1718.

In some demonstrative aspects, as shown in FIG. 17, system 1700 may include a polarization controller 1710, which may be configured to control a polarization for the plurality of Tx antennas 1707, and/or a polarization for the plurality of Rx antennas 1708. For example, polarization controller 1410 (FIG. 14) may include one or more elements of polarization controller 1710, and/or may perform one or more operations and/or functionalities of polarization controller 1710.

In some demonstrative aspects, as shown in FIG. 17, polarization controller 1710 may be configured to provide a control output 1725, which may be configured to control the polarization for at least one antenna of the plurality of Tx antennas 1707, and/or or to control the polarization for at least one antenna of the plurality of Rx antenna 1708, e.g., as described below.

In some demonstrative aspects, as shown in FIG. 17, control output 1725 may be configured to control the polarization for a Tx antenna 1707 of the plurality of Tx antennas 1707.

In some demonstrative aspects, as shown in FIG. 17, control output 1725, may be configured to control the polarization for an Rx antenna 1708 of the plurality of Rx antennas 1708.

In some demonstrative aspects, as shown in FIG. 17, control output 1725 may include a Tx control output 1727 to control the polarization for the plurality of Tx antennas 1707.

In some demonstrative aspects, as shown in FIG. 17, control output 1725 may include an Rx control output 1728 to control the polarization for the plurality of Rx antennas 1708.

In some demonstrative aspects, as shown in FIG. 17, Rx antenna 1708 may include a dual polarization Rx antenna including a first-polarization port (Pol. 1) corresponding to a first polarization, and a second polarization port (Pol. 2) corresponding to a second polarization.

In some demonstrative aspects, as shown in FIG. 17, Tx antenna 1707 may include a dual polarization Tx antenna including a first-polarization port (Pol. 1) corresponding to the first polarization, and a second polarization port (Pol. 2) corresponding to the second polarization.

In some demonstrative aspects, as shown in FIG. 17, Rx control output 1728 may be configured to control a polarization for the Rx antenna 1708, for example, according to a first weighting setting (Weighting Pol. 1) for the first polarization of the Rx antenna 1708, and a second weighting setting (Weighting Pol. 2) for the second polarization of the Rx antenna 1708.

In some demonstrative aspects, as shown in FIG. 17, Tx control output 1727 may be configured to control a polarization for the Tx antenna 1707, for example, according to a first weighting setting (Weighting Pol. 1) for the first polarization of the Tx antenna 1707, and a second weighting setting (Weighting Pol. 2) for the second polarization for the Tx antenna 1707.

In some demonstrative aspects, the first weighting setting and the second weighting setting may be implemented, for example, to support power normalization, e.g., according to a normalized unity power.

For example, the first weighting setting and the second weighting setting may be configured with a relation of a sine function and a cosine function, e.g., in case power normalization is implemented.

In one example, a 45° linear polarization with power normalization may be configured, for example, by configuring the first weighting setting to

$$\frac{\sqrt{2}}{2}$$

times a maximal gain, and by configuring the second weighting setting to

$$\frac{\sqrt{2}}{2}$$

times the maximal gain.

In another example, a 45° linear polarization without power normalization may be configured, for example, by configuring the first weighting setting to, and the second weighting setting to 1.

In some demonstrative aspects, system 1700 may be implemented to support an interference mitigation mechanism, which may be configured to provide a technical solution to support mitigation of an interferer signal, e.g., as described below.

In some demonstrative aspects, system 1700 may be configured to receive an Rx signal having substantially any polarization, e.g., at the plurality of Rx antennas 1708.

In one example, a polarization of the Rx signal may include a combination of a first polarization and a second polarization, which may form a basis of all possible polarizations that can be received by system 1700.

In some demonstrative aspects, polarization controller 1710 may be configured to analyze a polarization of an interferer signal.

In some demonstrative aspects, polarization controller 1710 may be configured to analyze, e.g., to separately analyze, a first-polarization component of the interferer signal and a second-polarization magnitude of the interferer signal.

In some demonstrative aspects, polarization controller 1710 may be configured to isolate the interferer signal, with a non-desired polarization, and to correct the first-polarization component and/or the second-polarization component of the Rx signal, for example, to cancel an interference from the interferer signal.

In one example, polarization controller 1710 may be configured to correct the first-polarization component and/or the second-polarization component of the Rx signal, for example, to mitigate, e.g., cancel, the interference from the interferer signal, for example, once polarization magnitudes of each axis of a polarization space are determined, for example, as described above with reference to FIG. 16.

In some demonstrative aspects, system 1700 may be configured to provide a technical solution to support adaptive polarization control, for example, to reduce, e.g., minimize, interference blockage from a blocker, for example, by setting a transmitted polarization for Tx signals and/or a received polarization for Rx signals, for example, to a polarization substantially orthogonal to a polarization of the blocker.

In some demonstrative aspects, polarization controller 1710 may be configured to set the first weighting setting for the first polarization, and/or the second weighting setting for the second polarization, for example, for each Tx chain 1707 and/or for each Rx chain 1708, for example, to generate a null in the polarization of the interference signal, for example, based on a substantially perfect cross polarization.

In one example, the Tx polarization may be aligned with the Rx polarization.

In another example, the first weighting setting for the first polarization, and the second weighting setting for the second polarization may include a phase setting and/or an amplitude setting.

In some demonstrative aspects, as shown in FIG. 17, a Tx chain 1717 may include a transmitter 1737, e.g., a dual polarization transmitter, connected to the dual-polarization Tx antenna 1707.

In some demonstrative aspects, as shown in FIG. 17, an Rx chain 1718 may include a receiver 1738, e.g., a dual-polarization receiver, connected to the dual-polarization Rx antenna 1708.

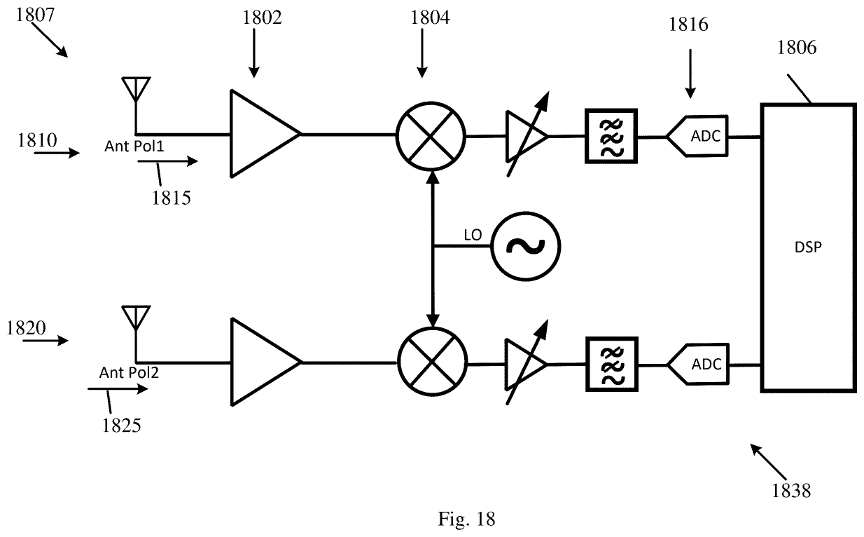

Reference is made to FIG. 18 which schematically illustrates a dual-polarization receiver 1838, in accordance with some demonstrative aspects. For example, receiver 1738 (FIG. 17) may include one or more elements of receiver 1838, and/or may perform one or more operations and/or functionalities of receiver 1838.

In some demonstrative aspects, as shown in FIG. 18, dual polarization receiver 1838 may include a first Rx chain 1810, which may be configured to receive a first Rx signal 1815 via a first antenna port, denoted Ant Pol1, of a dual-polarization antenna 1807, according to a first polarization, e.g., a horizontal polarization.

In some demonstrative aspects, as shown in FIG. 18, dual polarization receiver 1838 may include a second Rx chain 1820, which may be configured to receive a second Rx signal 1825 via a second antenna port, denoted Ant Pol2, of the dual-polarization antenna 1807 according to a second polarization, e.g., a vertical polarization.

In some demonstrative aspects, as shown in FIG. 18, dual-polarization receiver 1838 may include two LNAs 1802, for example, to amplify the first Rx signal 1815 and the second Rx signal 1825.

In some demonstrative aspects, as shown in FIG. 18, dual-polarization receiver 1838 may include two down-converters 1804, for example, to downconvert amplified Rx signals from the two LNAs 1802.

In some demonstrative aspects, as shown in FIG. 18, dual-polarization receiver 1838 may include two ADCs 1816, for example, to convert downconverted Rx signals from the two down-converters 1804 into digital Rx signals.

In some demonstrative aspects, as shown in FIG. 18, dual-polarization receiver 1838 may include a baseband processor 1806, e.g., a DSP and/or any other baseband processor, which may be configured to process the digital Rx signals.

In some demonstrative aspects, as shown in FIG. 18, dual polarization receiver 1838 may include a dual-processing chain architecture, e.g., including the first Rx chain 1810 and the second Rx chain 1820, for example, from the dual-polarization antenna 1807 via the two ADCs 1816 to the baseband processor 1806.

In some demonstrative aspects, as shown in FIG. 18, dual polarization receiver 1838 may be configured to implement the dual-processing chain architecture to provide a technical solution to support processing of the first Rx signal 1815 and the second Rx signal 1825 simultaneously. For example, dual polarization receiver 1838 may be configured to provide a technical solution to support a faster interference rejection, e.g., compared to a dual front-end polarization receiver, which may be configured for non-simultaneous processing.

In other aspects, a dual polarization receiver 1838 may include a dual front-end polarization receiver, for example, including a dual front-end chain and a single back-end chain.

In one example, the dual front-end polarization receiver may include dual-LNAs 1802 connected to the dual-polarization antenna 1807, and to a single ADC 1816.

For example, the dual front-end polarization receiver may include a combiner to combine the first Rx signal 1815 and the second Rx signal 1825, for example, after applying a proper relative weighting and phase shifting between polarizations of the first Rx signal 1815 and the second Rx signal 1825. According to this example, the back-end chain may include a standard chain, e.g., including a single copy of each component, for example, from the combiner to the baseband processor 1806.

In one example, the dual front-end polarization receiver may include two ADCs 1816, for example, to support a proper analysis of an accurate polarization of the interference signal. For example, for large arrays, an added cost of a chain including an additional ADC may be neglected.

In other aspects, the dual front-end polarization receiver may implement a search algorithm to search for a cross-polarization of the interferer, for example, by reducing, e.g., minimizing, a received signal power level, e.g., when the ego radar is muted, for example, to support the proper analysis of the accurate polarization of the interference signal.

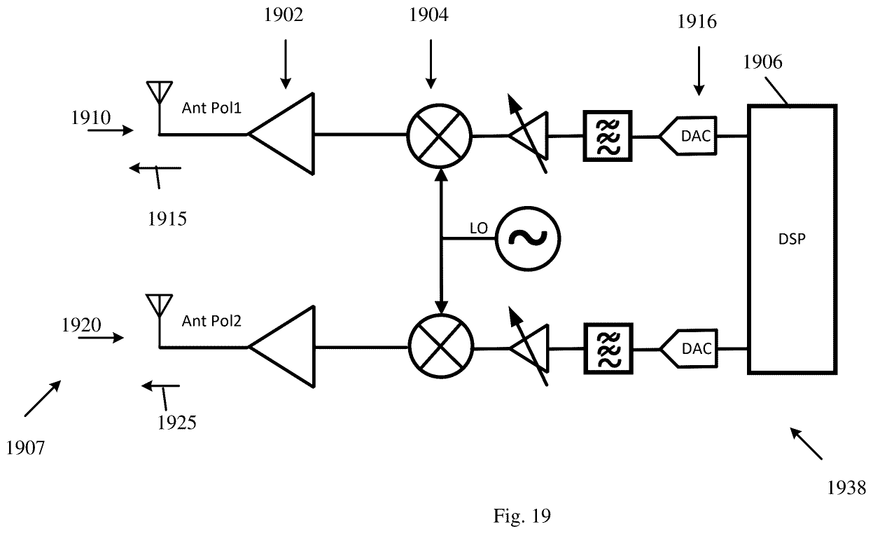

Reference is made to FIG. 19 which schematically illustrates a dual-polarization transmitter 1938, in accordance with some demonstrative aspects. For example, transmitter 1737 (FIG. 17) may include one or more elements of transmitter 1938, and/or may perform one or more operations and/or functionalities of transmitter 1938.

In some demonstrative aspects, as shown in FIG. 19, dual polarization transmitter 1938 may include a first Tx chain 1910, which may be configured to transmit a first Tx signal 1915 via a first antenna port, denoted Ant Pol1, of a dual-polarization antenna 1907, according to a first polarization, e.g., a horizontal polarization.

In some demonstrative aspects, as shown in FIG. 19, dual polarization transmitter 1938 may include a second Tx chain 1920, which may be configured to transmit a second Tx signal 1925 via a second antenna port, denoted Ant Pol2, of the dual-polarization antenna 1907 according to a second polarization, e.g., a vertical polarization.

In some demonstrative aspects, as shown in FIG. 19, dual-polarization transmitter 1938 may include two DACs 1916, for example, to convert digital Tx signals into analog Tx signals.

In some demonstrative aspects, as shown in FIG. 19, dual-polarization transmitter 1938 may include two up-converters 1904, for example, to upconvert the analog Tx signals.

In some demonstrative aspects, as shown in FIG. 19, dual-polarization transmitter 1938 may include two PAs 1902, for example, to amplify the upconverted analog Tx signals.

In some demonstrative aspects, as shown in FIG. 19, dual-polarization transmitter 1938 may include a baseband processor 1906, e.g., a DSP and/or any other baseband processor, which may be configured to generate the digital Tx signals.

In some demonstrative aspects, as shown in FIG. 19, dual polarization transmitter 1938 may include a dual-processing chain architecture, e.g., including the first Tx chain 1910 and the second Tx chain 1920, for example, from the baseband processor 1906 via the two DACs 1916 to the dual-polarization antenna 1907.

In some demonstrative aspects, as shown in FIG. 19, dual polarization transmitter 1938 may be configured to implement the dual-processing chain architecture to provide a technical solution to support processing of the first Tx signal 1915 and the second Tx signal 1925 simultaneously. For example, dual polarization transmitter 1938 may be configured to provide a technical solution to support a faster interference rejection, e.g., compared to a dual front-end polarization transmitter, which may be configured for non-simultaneous processing.

In other aspects, a dual polarization transmitter 1938 may include a dual front-end polarization transmitter, for example, including a dual front-end chain and a single back-end chain.

For example, the dual front-end polarization transmitter may include dual-PAs 1902 connected to the dual-polarization antenna 1907, and a single DAC 1916.

For example, the dual front-end polarization transmitter may include a splitter to split a Tx signal into the first Tx signal 1915 and the second Tx signal 1925, for example, after applying a proper relative weighting and phase shifting between polarizations of the first Tx signal 1915 and the second Tx signal 1925. According to this example, the back-end chain may include a standard chain, e.g., including a single copy of each component, for example, from the baseband processor 1906 to the splitter.

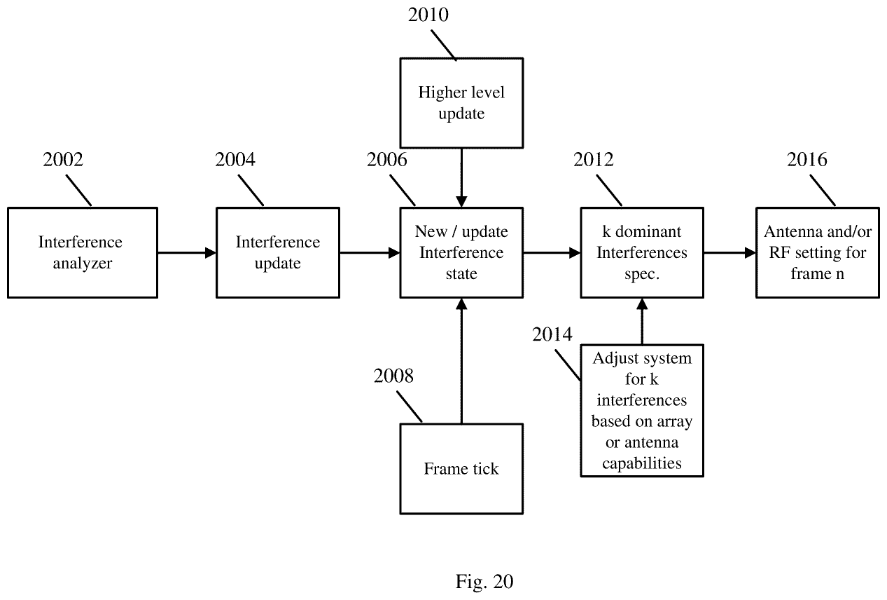

Reference is made to FIG. 20, which schematically illustrates a method of determining a polarization setting of an antenna, in accordance with some demonstrative aspects. For example, one or more of the operations of the method of FIG. 20 may be performed by a radar system, e.g., radar system 900 (FIG. 9), and/or system 1400 (FIG. 14); a radar device, e.g., radar device 800 (FIG. 8); a radar front-end, e.g., radar front-end 804 (FIG. 8); a controller, e.g., polarization controller 1410 (FIG. 14); and/or a processor, e.g., processor 1422 (FIG. 14).

In some demonstrative aspects, as indicated at block 2002, the method may include determining an interferer, e.g., a dominant interferer or a candidate to be a dominant interferer.

For example, processor 1422 (FIG. 14) may be configured to identify the interferer, e.g., by processing one or more radar data frames, for example, based on an SINR monitoring mechanism, an interference source power estimation, and/or any other additional and/or alternative interference detection method.

In some demonstrative aspects, as indicated at block 2004, the method may include updating interference information of an interferer signal from the interferer, for example, to determine expected interference information, e.g., a location and/or a direction, of the interferer signal.

In one example, processor 1422 (FIG. 14) may be configured to determine a spatial solid angle of the interferer signal.

In another example, processor 1422 (FIG. 14) may be configured to determine a future solid angle of the interferer signal, for example, based on a moving state of the ego radar and the interferer. For example, processor 1422 (FIG. 14) may be configured to determine a change of the polarization of the interferer signal, for example, based on a solid angle change and evolution.

In some demonstrative aspects, as indicated at block 2006, the method may include updating a polarization setting for a Tx antenna and/or an Rx antenna, for example, to mitigate, e.g., reduce or minimize, an interference level of the interferer signal.

In one example, processor 1422 (FIG. 14) may be configured to mitigate the interference from the interferer signal, for example, by configuring polarizations for receiving a first polarization of the interferer signal and a second polarization of the interferer signal, e.g., separately.

For example, processor 1422 (FIG. 14) may be configured to find a dominant polarization out of the first polarization and the second polarization.

For example, processor 1422 (FIG. 14) may be configured to determine an angle of the interferer signal, and to determine the non-dominant polarization as the preferred dominant EGO polarization to be set by the processor.

For example, processor 1422 (FIG. 14) may be configured to determine the polarization setting for dominant EGO polarization, for example, based on a rotation of the angle of the interferer signal polarization, e.g., by 90 degrees, e.g., such that the dominant EGO polarization may be substantially orthogonal to the dominant polarization of the interferer signal, e.g., a cross-polarization to the dominant polarization.

In one example, an interference signal may include a first-polarization magnitude X along the x-axis, and a second-polarization magnitude Y along the y-axis. For example, the first-polarization magnitude X may be the dominant polarization, e.g., X>Y, and may have an angle θ, e.g., θ=tan⁻¹ (Y/X) from the x-axis. According to this example, a polarization of an antenna may be set along an axis, which has an angle θ from the y-axis.

In some demonstrative aspects, as indicated at block 2008, the method may include repeating the operations of block 2006, for example, for every frame, every period, or at any other suitable periodicity.

In some demonstrative aspects, as indicated at block 2010, updating the polarization setting for the Tx antenna and/or the Rx antenna may be based on information from a higher level, e.g., additional information from the higher level with respect to the interferer signal.

In some demonstrative aspects, as indicated at block 2012, the method may include determining a plurality of dominant interferers.

For example, processor 1422 (FIG. 14) may be configured to determine a plurality of dominant interferes, for example, in case of a plurality of interference sources with similar power, or in case of any other scenario.

In one example, processor 1422 (FIG. 14) may be configured to determine a mitigation scheme, e.g., a global optimization of Tx and Rx radio resources of the ego utilization, for example, to reduce an overall interference level, for example, based on an overall interference source behavior analysis. For example, the Tx and Rx radio resources may include, for example, a polarization, a time of transmission, a frequency, a BW, a waveform, a code scheme, and/or any other additional and/or alternative radio resources.

In some demonstrative aspects, as indicated at block 2014, the method may include adjusting the Tx and Rx radio resources to mitigate interference from the plurality of dominant interferers, for example, based on one or more antenna capabilities corresponding to the Tx and Rx radio resources.

In some demonstrative aspects, as indicated at block 2016, the method may include outputting the polarization setting of the antenna, e.g., per frame.

In one example, the method may be repeated, for example, every time a frequency is modified, for example, as the cross polarization of the antenna, e.g., over its entire FoV, may be frequency dependent.

In some demonstrative aspects, processor 1422 (FIG. 14) may be configured to control a plurality sub-arrays, which may be steered to different azimuth and/or elevation sections, e.g., in a predefined FOV, for example, to mitigate a plurality of dominant interferes, e.g., as described below.

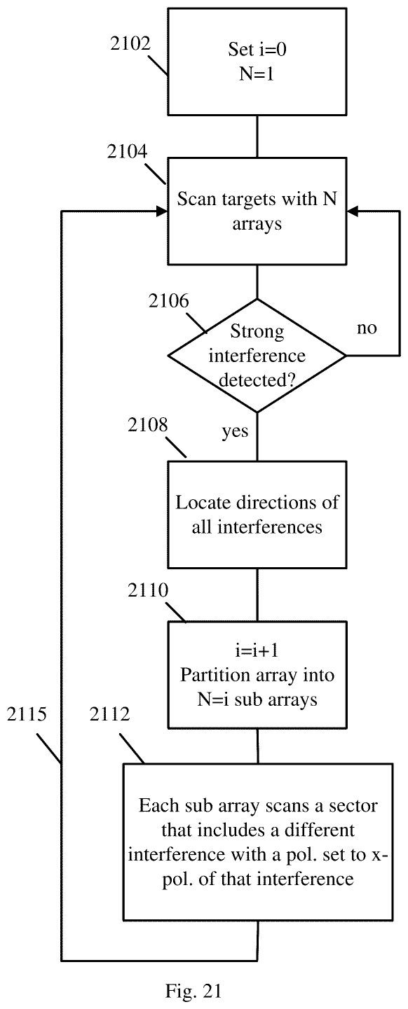

Reference is made to FIG. 21, which schematically illustrates a method of determining one or more polarization settings of one or more sub-arrays of an antenna, in accordance with some demonstrative aspects, For example, one or more of the operations of the method of FIG. 21 may be performed by a radar system, e.g., radar system 900 (FIG. 9), and/or system 1400 (FIG. 14); a radar device, e.g., radar device 800 (FIG. 8); a radar front-end, e.g., radar front-end 804 (FIG. 8); a controller, e.g., polarization controller 1410 (FIG. 14); and/or a processor, e.g., processor 1422 (FIG. 14).

In some demonstrative aspects, as indicated at block 2102, the method may include setting a number of interferers, denoted i, to zero, and a number of subarrays of the antenna, denoted N, to one.

For example, processor 1422 (FIG. 14) may be configured to set the number of interferers to one, and the number of sub-arrays to one, e.g., representing a sub-array including all antennas.

In some demonstrative aspects, as indicated at block 2104, the method may include scanning for one or more interferers with the N sub-arrays.

For example, processor 1422 (FIG. 14) may be configured to scan for the one or more interferers using the N sub-arrays.

In some demonstrative aspects, as indicated at block 2106, the method may include determining whether or not an interferer is detected.

For example, processor 1422 (FIG. 14) may be configured to determine whether or not an interferer is detected.

In some demonstrative aspects, as indicated at block 2104, the method may include continuing to scan for interferers with the N sub-arrays, for example, based on a determination that another interferer is not detected.

In some demonstrative aspects, as indicated at block 2108, the method may include determining directions of the i detected interferers, for example, based on a determination that an interferer is detected.

For example, processor 1422 (FIG. 14) may be configured to determine the angles of the detected interferers relative to the boresight of the antenna.

In some demonstrative aspects, as indicated at block 2110, the method may include partitioning the antenna into N=i sub-arrays, e.g., such that each sub-array may correspond to a respective interferer.

For example, processor 1422 (FIG. 14) may be configured to set the number of sub-arrays to two, and to partition the antenna into two sub-arrays.

In some demonstrative aspects, as indicated at block 2112, the method may include setting polarization settings for the N sub-arrays, for example, based on a angles of the interferers corresponding to the N sub-arrays.

For example, processor 1422 (FIG. 14) may be configured to set a first polarization of a first antenna sub-array based on, e.g., to be orthogonal to, a polarization of a first interferer at a first angle, and to set a second polarization of a second antenna sub-array based on, e.g., to be orthogonal to, a polarization of a second interferer at a second angle.

In some demonstrative aspects, as indicated by arrow 2115, the method may include repeating the operations of blocks 2104-2112, for example, to scan for additional interferers using the updated number of N antenna sub-arrays.

In some demonstrative aspects, processor 1422 (FIG. 14) may be configured to implement one or more operations of the method of FIG. 21, for example, to mitigate interference from a plurality of interferer signals.

In some demonstrative aspects, processor 1422 (FIG. 14) may be configured to mitigate interference from a plurality of interferer signals, for example, based on a trial and error concept.

In some demonstrative aspects, an antenna sub-array, e.g., each antenna sub-array, may be configured to handle a single major interference in its section, for example, based on angle-based information, which is based on an angle of the single major interference.

In some demonstrative aspects, processor 1422 (FIG. 14) may be configured to mitigate the interference from the plurality of interferer signals, for example, using the plurality of antenna sub-arrays, for example, when applying a low level of overlapping in the FOV, e.g., between the plurality of antenna sub-arrays, and/or assuming each of the plurality of interferer signals is in a different section, which is covered solely by a dedicated sub-array of the plurality of antenna sub-arrays.

In some demonstrative aspects, processor 1422 (FIG. 14) may be configured to mitigate interference from the plurality of interferer signals, for example, using the plurality of antenna sub-arrays, for example, assuming a number of the plurality of antenna sub-arrays is greater or equal to the number of interferers.

In one example, an overlap between FoVs of the plurality of antenna sub-arrays may be tolerated, for example, when an RF chain itself is not compressed by each interference. Accordingly, a requirement for no-overlap between the FOVs of the antenna sub-arrays may have low importance.

In some demonstrative aspects, one or more operations of the method of FIG. 21 may be implemented to provide a technical solution to support mitigation of interference form one or more interferer signals, for example, in a bi-directional road scenario. For example, one antenna sub-array may be polarization-tuned, for example, to reject a first interference from a same lane, e.g., from a vehicle in a front direction of the ego radar. For example, another antenna sub-array may be polarization-tuned, for example, to reject a second interference from incoming traffic in an adjacent lane. For example, the incoming traffic may be travelling in an opposite direction to the ego radar, e.g., similar to the interference scenario 1200 (FIG. 12).

In some demonstrative aspects, the method of FIG. 21, may be configured to provide a technical solution to support mitigation of interference from one or more interferer signals, for example, in a multi lane traffic scenario. For example, each antenna sub-array may be used to mitigate interference from next in line vehicles traveling in a same direction as the ego radar, where each sub-array may be used to cover a different lane, e.g., for close distances.

In some demonstrative aspects, the method of FIG. 21, may be configured to provide a technical solution to support mitigation of interference from one or more interferer signals, for example, in a junction scenario, for example, to mitigate interference from traffic approaching from a crossing road, e.g., from the left and/or from the right, for example, similar to the interference scenario 1300 (FIG. 13).

In some demonstrative aspects, processor 1422 (FIG. 14) may be configured to mitigate interference from a plurality of interferer signals, for example, by controlling one or more specific time windows for the ego radar, for example, to reduce instantaneous interference to a single interference, and to mitigate interference from the single interference, for example, based on the one or more operations of the method of FIG. 20.

In some demonstrative aspects, processor 1422 (FIG. 14) may be configured to mitigate interference from a plurality of interferer signals, for example, using active polarizers, which may adaptively change a polarization of an antenna, which may have a single polarization and therefore a single port. For example, an active polarizer may be relevant for a single interference scenario. For example, the active polarizer may be implemented to replace a dual-polarization antenna, e.g., dual-polarization Tx antenna 1707 (FIG. 17), and/or dual-polarization Rx antenna 1708 (FIG. 17).

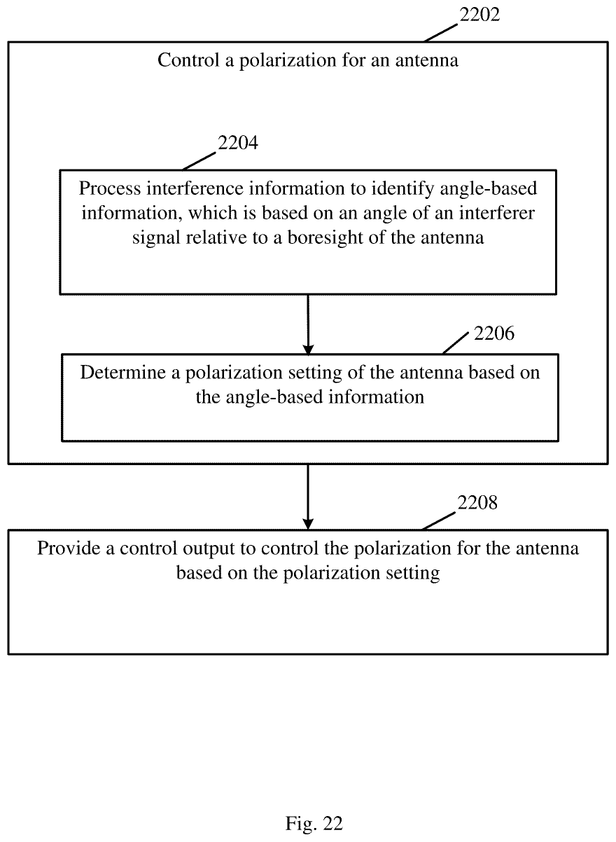

Reference is made to FIG. 22, which schematically illustrates a method of controlling a polarization for an antenna, in accordance with some demonstrative aspects/For example, one or more of the operations of the method of FIG. 20 may be performed by a radar system, e.g., radar system 900 (FIG. 9), and/or system 1400 (FIG. 14); a radar device, e.g., radar device 800 (FIG. 8); a radar front-end, e.g., radar front-end 804 (FIG. 8); a controller, e.g., polarization controller 1410 (FIG. 14); and/or a processor, e.g., processor 1422 (FIG. 14).

As indicated at block 2202, the method may include controlling a polarization for an antenna. For example, polarization controller 1410 (FIG. 14) may be configured to control the polarization for the antenna 1430 (FIG. 14), e.g., as described above.

As indicated at block 2204, controlling the polarization for the antenna may include processing interference information to identify angle-based information, which may be based on an angle of an interferer signal relative to a boresight of the antenna. For example, processor 1422 (FIG. 14) may be configured to process the interference information 1415 (FIG. 14) to identify the angle-based information, which may be based on the angle of the interferer signal 1452 (FIG. 14) relative to the boresight 1439 (FIG. 14) of the antenna 1430 (FIG. 14), e.g., as described above.

As indicated at block 2206, controlling the polarization for the antenna may include determining a polarization setting of the antenna based on the angle-based information. For example, processor 1422 (FIG. 14) may be configured to determine the polarization setting 1425 (FIG. 14) of the antenna 1430 (FIG. 14), for example, based on the angle-based information, e.g., as described above.

As indicated at block 2208, the method may include providing a control output to control the polarization for the antenna based on the polarization setting. For example, processor 1422 (FIG. 14) may be configured to control output 1426 (FIG. 14) to provide the control output 1428 (FIG. 14) to control the polarization for the antenna 1430 (FIG. 14), for example, based on the polarization setting 1425 (FIG. 14), e.g., as described above.

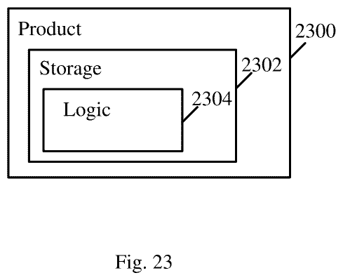

Reference is made to FIG. 23, which schematically illustrates a product of manufacture 2300, in accordance with some demonstrative aspects. Product 2300 may include one or more tangible computer-readable (“machine-readable”) non-transitory storage media 2302, which may include computer-executable instructions, e.g., implemented by logic 2304, operable to, when executed by at least one computer processor, enable the at least one computer processor to implement one or more operations and/or functionalities described with reference to any of the FIGS. 1-22, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 2300 and/or machine-readable storage media 2302 may include one or more types of computer-readable storage media capable of storing data, including volatile memory, non-volatile memory, removable or non-removable memory, erasable or non-erasable memory, writeable or re-writeable memory, and the like. For example, machine-readable storage media 2302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 2304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 2304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a polarization controller configured to control a polarization for an antenna, the polarization controller comprising a processor configured to process interference information to identify angle-based information, which is based on an angle of an interferer signal relative to a boresight of the antenna; and determine a polarization setting of the antenna based on the angle-based information; and an output to provide a control output to control the polarization for the antenna based on the polarization setting.

Example 2 includes the subject matter of Example 1, and optionally, wherein the processor is configured to determine the polarization setting of the antenna based on the angle-based information such that a cross-polarization (Xpol) ratio at the angle of the interferer signal is at least 20 decibel (dB), wherein the Xpol ratio at the angle of the interferer signal comprises a ratio between a co-polarization of the antenna at the angle of the interferer signal and a cross-polarization of the antenna at the angle of the interferer signal.

Example 3 includes the subject matter of Example 2, and optionally, wherein the processor is configured to determine the polarization setting of the antenna based on the angle-based information such that the Xpol ratio at the angle of the interferer signal is between 20 dB and 55 dB.

Example 4 includes the subject matter of Example 2 or 3, and optionally, wherein the processor is configured to determine the polarization setting of the antenna based on the angle-based information such that the Xpol ratio at the angle of the interferer signal is at least 30 dB.

Example 5 includes the subject matter of any one of Examples 2-4, and optionally, wherein the processor is configured to determine the polarization setting of the antenna based on the angle-based information such that the Xpol ratio at the angle of the interferer signal is at least 40 dB.

Example 6 includes the subject matter of any one of Examples 2-5, and optionally, wherein the processor is configured to determine the polarization setting of the antenna based on the angle-based information such that the Xpol ratio at the angle of the interferer signal is at least 50 dB.

Example 7 includes the subject matter of any one of Examples 1-6, and optionally, wherein the processor is configured to determine the polarization setting of the antenna to comprise a first polarization setting prior to identifying the angle-based information corresponding to the interferer signal, and to determine the polarization setting of the antenna to comprise a second polarization setting based on the angle-based information corresponding to the interferer signal, wherein a cross-polarization (Xpol) ratio at the angle of the interferer signal according to the second polarization setting is greater than an Xpol ratio at the angle of the interferer signal according to the first polarization setting, wherein the Xpol ratio at the angle of the interferer signal comprises a ratio between a co-polarization of the antenna at the angle of the interferer signal and a cross-polarization of the antenna at the angle of the interferer signal.

Example 8 includes the subject matter of any one of Examples 1-7, and optionally, wherein the processor is configured to determine the polarization setting of the antenna such that the polarization setting of the antenna is orthogonal to a polarization of the interferer signal.

Example 9 includes the subject matter of any one of Examples 1-8, and optionally, wherein the processor is configured to process the interference information to identify a first-polarization component of the interferer signal and a second-polarization component of the interferer signal, wherein the first-polarization component corresponds to a first polarization and the second-polarization component corresponds to a second polarization substantially orthogonal to the first polarization, wherein the processor is configured to determine the polarization setting of the antenna based on the first-polarization component and the second-polarization component.

Example 10 includes the subject matter of Example 9, and optionally, wherein the processor is configured to determine the polarization setting of the antenna based on a magnitude of the first-polarization component and a magnitude of the second-polarization component.

Example 11 includes the subject matter of Example 9 or 10, and optionally, wherein the processor is configured to determine the polarization setting of the antenna to include a first-polarization setting corresponding to the first polarization and a second-polarization setting corresponding to the second polarization, wherein the first-polarization setting is based on a magnitude of the second-polarization component of the interferer signal, and the second-polarization setting is based on a magnitude of the first-polarization component of the interferer signal.

Example 12 includes the subject matter of any one of Examples 9-11, and optionally, wherein the processor is configured to determine the polarization setting of the antenna to include a first-polarization setting corresponding to the first polarization and a second-polarization setting corresponding to the second polarization, wherein the first-polarization setting is equal to an additive inverse of a magnitude of the second-polarization component of the interferer signal, and the second-polarization setting is equal to a magnitude of the first-polarization component of the interferer signal.

Example 13 includes the subject matter of any one of Examples 9-12, and optionally, wherein the processor is configured to determine the polarization setting of the antenna to include a first-polarization setting corresponding to the first polarization and a second-polarization setting corresponding to the second polarization, wherein a phase difference between the first-polarization setting and the second-polarization setting is based on a phase difference between the first-polarization component and the second-polarization component.

Example 14 includes the subject matter of Example 13, and optionally, wherein the phase difference between the first-polarization setting and the second-polarization setting is equal to an additive inverse of the phase difference between the first-polarization component and the second-polarization component.

Example 15 includes the subject matter of any one of Examples 9-14, and optionally, wherein the first-polarization component comprises a Vertical-polarization (V-polarization) component and the second-polarization component comprises a Horizontal-polarization (H-polarization) component.

Example 16 includes the subject matter of any one of Examples 1-15, and optionally, wherein the processor is configured to processes the interference information to identify the angle of the interferer signal relative to the boresight of the antenna, and to determine the polarization setting of the antenna based on the angle of the interferer signal relative to the boresight of the antenna.

Example 17 includes the subject matter of Example 16, and optionally, wherein the processor is configured to retrieve the polarization setting of the antenna from a Look Up Table (LUT) based on the angle of the interferer signal, wherein the LUT comprises a plurality of predefined polarization settings corresponding to a plurality of predefined angles.

Example 18 includes the subject matter of any one of Examples 1-17, and optionally, wherein the processor is configured to identify first angle-based information, which is based on a first angle of a first interferer signal relative to the boresight of the antenna, and to determine a first polarization setting of the antenna based on the first angle-based information, wherein the processor is configured to identify second angle-based information, which is based on a second angle of a second interferer signal relative to the boresight of the antenna, and to determine a second polarization setting of the antenna based on the second angle-based information, wherein the first polarization setting is different from the second polarization setting.

Example 19 includes the subject matter of Example 18, and optionally, wherein the first angle-based information is different from the second angle-based information.

Example 20 includes the subject matter of Example 18 or 19, and optionally, wherein the first angle of the first interferer signal relative to the boresight of the antenna is different from the second angle of the second interferer signal relative to the boresight of the antenna.

Example 21 includes the subject matter of any one of Examples 1-20, and optionally, wherein the processor is configured to identify first angle-based information, which is based on a first angle of a first interferer signal relative to the boresight of the antenna, to identify second angle-based information, which is based on a second angle of a second interferer signal relative to the boresight of the antenna, and to determine the polarization setting of the antenna based on the first angle-based information and the second angle-based information.

Example 22 includes the subject matter of any one of Examples 1-21, and optionally, wherein the processor is configured to determine a first polarization setting of the antenna based on first angle-based information, which is based on the angle of the interferer signal, wherein the processor is configured to determine a second polarization setting of the antenna based on second angle-based information, which is based on the angle of the interferer signal, wherein the first angle-based information is different from the second angle-based information, wherein the first polarization setting is different from the second polarization setting.

Example 23 includes the subject matter of any one of Examples 1-22, and optionally, wherein the processor is configured to determine a first polarization setting of a first sub-array of the antenna based on first angle-based information, which is based on a first angle of a first interferer signal relative to the boresight of the antenna, wherein the processor is configured to determine a second polarization setting of a second sub-array of the antenna based on second angle-based information, which is based on a second angle of a second interferer signal relative to the boresight of the antenna.

Example 24 includes the subject matter of Example 23, and optionally, wherein a Field of View (FoV) of the first sub-array comprises the first angle of the first interferer signal, wherein a FoV of the second sub-array comprises the second angle of the second interferer signal.

Example 25 includes the subject matter of any one of Examples 1-24, and optionally, wherein the polarization setting of the antenna comprises a first setting for a Horizontal-polarization (H-pol) port of the antenna, and a second setting for a Vertical-polarization (V-pol) port of the antenna.

Example 26 includes the subject matter of any one of Examples 1-25, and optionally, wherein the polarization setting of the antenna comprises at least one setting of a phase setting or an amplitude setting.

Example 27 includes the subject matter of any one of Examples 1-26, and optionally, wherein the polarization setting of the antenna comprises a Receive (Rx) polarization setting to receive an Rx signal via the antenna.

Example 28 includes the subject matter of any one of Examples 1-27, and optionally, wherein the polarization setting of the antenna comprises a transmit (Tx) polarization setting to transmit a Tx signal via the antenna.

Example 29 includes the subject matter of any one of Examples 1-28, and optionally, comprising the antenna, and a Radio Frequency (RF) chain to communicate a signal via the antenna based on the polarization setting.

Example 30 includes the subject matter of any one of Examples 1-29, and optionally, comprising a radar device, the radar device comprising a plurality of Transmit (Tx) antennas connected to a plurality of Tx chains, a plurality of Rx antennas connected to a plurality of Rx chains, and a radar processor to generate radar information based on radar Rx signals processed by the plurality of Rx chains, wherein the control output is to control the polarization for at least one antenna of the plurality of Tx antennas or the plurality of Rx antennas.

Example 31 includes the subject matter of Example 30, and optionally, comprising a vehicle, the vehicle comprising the radar device, and a system controller to control one or more systems of the vehicle based on the radar information.

Example 32 includes a device comprising the apparatus of any of Examples 1-31 and a communication interface to communicate signals via the antenna.

Example 33 includes a polarization controller configured to control a polarization for an antenna according to any of Examples 1-31.

Example 34 includes a device comprising an antenna, a communication interface to communicate signals via the antenna, and a polarization controller configured to control a polarization for the antenna according to any of Examples 1-31.

Example 35 comprises a product comprising one or more tangible computer-readable non-transitory storage media comprising instructions operable to, when executed by at least one processor, enable the at least one processor to cause a device to perform any of the described operations of any of Examples 1-31.

Example 36 includes a method of controlling a polarization for an antenna according to any of Examples 1-31.

Example 37 includes an apparatus comprising means for controlling a polarization for an antenna according to any of Examples 1-31.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a polarization controller configured to control a polarization for an antenna, the polarization controller comprising:
a processor configured to:
process interference information to identify angle-based information, which is based on an angle of an interferer signal relative to a boresight of the antenna; and
determine a polarization setting of the antenna based on the angle-based information; and
an output to provide a control output to control the polarization for the antenna based on the polarization setting.

2. The apparatus of claim 1, wherein the processor is configured to determine the polarization setting of the antenna based on the angle-based information such that a cross-polarization (Xpol) ratio at the angle of the interferer signal is at least 20 decibel (dB), wherein the Xpol ratio at the angle of the interferer signal comprises a ratio between a co-polarization of the antenna at the angle of the interferer signal and a cross-polarization of the antenna at the angle of the interferer signal.

3. The apparatus of claim 2, wherein the processor is configured to determine the polarization setting of the antenna based on the angle-based information such that the Xpol ratio at the angle of the interferer signal is between 20 dB and 55 dB.

4. The apparatus of claim 2, wherein the processor is configured to determine the polarization setting of the antenna based on the angle-based information such that the Xpol ratio at the angle of the interferer signal is at least 30 dB.

5. The apparatus of claim 1, wherein the processor is configured to determine the polarization setting of the antenna to comprise a first polarization setting prior to identifying the angle-based information corresponding to the interferer signal, and to determine the polarization setting of the antenna to comprise a second polarization setting based on the angle-based information corresponding to the interferer signal, wherein a cross-polarization (Xpol) ratio at the angle of the interferer signal according to the second polarization setting is greater than an Xpol ratio at the angle of the interferer signal according to the first polarization setting, wherein the Xpol ratio at the angle of the interferer signal comprises a ratio between a co-polarization of the antenna at the angle of the interferer signal and a cross-polarization of the antenna at the angle of the interferer signal.

6. The apparatus of claim 1, wherein the processor is configured to determine the polarization setting of the antenna such that the polarization setting of the antenna is orthogonal to a polarization of the interferer signal.

7. The apparatus of claim 1, wherein the processor is configured to process the interference information to identify a first-polarization component of the interferer signal and a second-polarization component of the interferer signal, wherein the first-polarization component corresponds to a first polarization and the second-polarization component corresponds to a second polarization substantially orthogonal to the first polarization, wherein the processor is configured to determine the polarization setting of the antenna based on the first-polarization component and the second-polarization component.

8. The apparatus of claim 7, wherein the processor is configured to determine the polarization setting of the antenna based on a magnitude of the first-polarization component and a magnitude of the second-polarization component.

9. The apparatus of claim 7, wherein the processor is configured to determine the polarization setting of the antenna to include a first-polarization setting corresponding to the first polarization and a second-polarization setting corresponding to the second polarization, wherein the first-polarization setting is based on a magnitude of the second-polarization component of the interferer signal, and the second-polarization setting is based on a magnitude of the first-polarization component of the interferer signal.

10. The apparatus of claim 7, wherein the processor is configured to determine the polarization setting of the antenna to include a first-polarization setting corresponding to the first polarization and a second-polarization setting corresponding to the second polarization, wherein the first-polarization setting is equal to an additive inverse of a magnitude of the second-polarization component of the interferer signal, and the second-polarization setting is equal to a magnitude of the first-polarization component of the interferer signal.

11. The apparatus of claim 7, wherein the processor is configured to determine the polarization setting of the antenna to include a first-polarization setting corresponding to the first polarization and a second-polarization setting corresponding to the second polarization, wherein a phase difference between the first-polarization setting and the second-polarization setting is based on a phase difference between the first-polarization component and the second-polarization component.

12. The apparatus of claim 11, wherein the phase difference between the first-polarization setting and the second-polarization setting is equal to an additive inverse of the phase difference between the first-polarization component and the second-polarization component.

13. The apparatus of claim 1, wherein the processor is configured to processes the interference information to identify the angle of the interferer signal relative to the boresight of the antenna, and to determine the polarization setting of the antenna based on the angle of the interferer signal relative to the boresight of the antenna.

14. The apparatus of claim 13, wherein the processor is configured to retrieve the polarization setting of the antenna from a Look Up Table (LUT) based on the angle of the interferer signal, wherein the LUT comprises a plurality of predefined polarization settings corresponding to a plurality of predefined angles.

15. The apparatus of claim 1, wherein the processor is configured to identify first angle-based information, which is based on a first angle of a first interferer signal relative to the boresight of the antenna, and to determine a first polarization setting of the antenna based on the first angle-based information, wherein the processor is configured to identify second angle-based information, which is based on a second angle of a second interferer signal relative to the boresight of the antenna, and to determine a second polarization setting of the antenna based on the second angle-based information, wherein the first polarization setting is different from the second polarization setting.

16. The apparatus of claim 1, wherein the processor is configured to identify first angle-based information, which is based on a first angle of a first interferer signal relative to the boresight of the antenna, to identify second angle-based information, which is based on a second angle of a second interferer signal relative to the boresight of the antenna, and to determine the polarization setting of the antenna based on the first angle-based information and the second angle-based information.

17. The apparatus of claim 1, wherein the processor is configured to determine a first polarization setting of a first sub-array of the antenna based on first angle-based information, which is based on a first angle of a first interferer signal relative to the boresight of the antenna, wherein the processor is configured to determine a second polarization setting of a second sub-array of the antenna based on second angle-based information, which is based on a second angle of a second interferer signal relative to the boresight of the antenna.

18. The apparatus of claim 17, wherein a Field of View (FoV) of the first sub-array comprises the first angle of the first interferer signal, wherein a FoV of the second sub-array comprises the second angle of the second interferer signal.

19. The apparatus of claim 1, wherein the polarization setting of the antenna comprises a first setting for a Horizontal-polarization (H-pol) port of the antenna, and a second setting for a Vertical-polarization (V-pol) port of the antenna.

20. The apparatus of claim 1, wherein the polarization setting of the antenna comprises at least one setting of a phase setting or an amplitude setting.

21. The apparatus of claim 1 comprising the antenna, and a Radio Frequency (RF) chain to communicate a signal via the antenna based on the polarization setting.

22. A radar device comprising:
one or more Transmit (Tx) antennas connected to one or more Tx chains;
one or more Rx antennas connected to one or more Rx chains;
a polarization controller configured to control a polarization for at least one antenna of the one or more Tx antennas or the one or more Rx antennas, the polarization controller comprising a processor configured to process interference information to identify angle-based information, which is based on an angle of an interferer signal relative to a boresight of the antenna, and to determine a polarization setting of the antenna based on the angle-based information; and
a radar processor to generate radar information based on radar Rx signals processed by the one or more Rx chains.

23. The radar device of claim 22, wherein the polarization controller is configured to determine the polarization setting of the antenna based on the angle-based information such that a cross-polarization (Xpol) ratio at the angle of the interferer signal is at least 20 decibel (dB), wherein the Xpol ratio at the angle of the interferer signal comprises a ratio between a co-polarization of the antenna at the angle of the interferer signal and a cross-polarization of the antenna at the angle of the interferer signal.
